(19) United States
(12) Patent Application Publication
(10) Pub. No.: US 2009/0050589 A1
(43) Pub. Date: Feb. 26, 2009

(54) Quick Assembly Retail Product Display System and Method for Shipping and Display of Retail Products

(76) Inventors: David James Pedler, Kernersville, NC (US); James L. Einstein, Winston Salem, NC (US); Davey Shealey, Lewisville, NC (US)

Correspondence Address: JOHN S. PRATT - 38949;KILPATRICK STOCKTON LLP, 1100 PEACHTREE STREET, SUITE 2800, ATLANTA, GA, 30309, US

(21) Appl. No.: 12/195,931

(22) Filed: Aug. 21, 2008

Related U.S. Application Data
(60) Provisional application No. 60/965,585, filed on Aug. 21, 2007.
(60) Provisional application No. 60/967,877, filed on Sep. 7, 2007.

(51) Int. Cl. A47F 7/00; A47B 43/00; A47F 3/14; G09F 7/00; B23P 11/00

(52) U.S. Cl. 211/85.8; 211/195; 211/126.1; 40/584; 29/428

(57) ABSTRACT

A quick assembly retail product display system providing efficient display of retail product. One embodiment of the display system includes a rack, display trays, clips used to mount the display trays on the rack, and graphic components. Retail product is packaged and shipped within the display trays, allowing the display trays and product to be put on display without removing the retail product from the trays. Clips are removably mounted to the rack, allowing multiple configurations of the display system. The rack portion of the display system can be quickly set up and is collapsible when not in use. Additionally, the rack is easily movable, allowing the rack to be placed in many different locations. The graphic components provide advertising space and are available in a variety of shapes and sizes to enhance the appearance of the display system.

### CROSS REFERENCE TO RELATED APPLICATIONS

This application claims the priority of U.S. provisional application Ser. No. 60/965,585, entitled “Quick Assembly Retail Product Display System”, filed Aug. 21, 2007, and U.S. provisional application Ser. No. 60/967,877, entitled “Quick Assembly Retail Product Display System and Method for Shipping and Display”, filed Sep. 7, 2007, the entire contents of each of which are hereby incorporated by this reference.

### FIELD OF INVENTION

This invention generally relates to retail product displays and methods of shipping and displaying retail products.

### BACKGROUND OF INVENTION

Retailers of consumer product face issues related to obtaining and displaying retail product, ranging from what products to obtain, how to ship those products, and how to display the products quickly and completely in the smallest amount of time possible.

Retailers attempt to solve some of these problems by shipping the retail products in their displays. Particular distributors employ display suppliers to develop a display for particular products, including appropriate graphics. Typically, a third party assembles the display components and packs the display with product. The third party may stretch wrap the display and product for shipping.

While combining the product and display in one step eliminates setup time, problems are created through this method. First, displays are generally developed for only one product. Different products, such as DVDs of various titles, may not be shipped nor displayed in this method. Also, since the display already has graphics and advertisements attached, they are exposed to the possibility of damage during shipping. Additionally, the stretch wrapped material may be easily punctured, leading to damaged product. Furthermore, the size and bulk of the display with product mounted can increase the chances of such damages, as well as limit the means of shipment. In addition, parcel shipping is not available for such a combination, leading many retailers/distributors to ship less than truckload (LTL), which is a costly method. LTL delivery times are not guaranteed, so there is no set time as to when the product will be delivered.

When delivered, the retailer may initiate a product count to ensure that the number received matches the number listed on the invoice requiring employees to remove all packaging material from the display and hand count the product. Once completed, the display is repackaged with new material and stored until ready for display. This process creates additional work and increases costs for the retailer. Additionally, the display requires storage space. Since a half pallet display usually runs 48″ by 24″, a significant amount of space is needed.

A hand truck must be used to move the half pallet display from the store room to the retail floor. Packaging is then removed and the product is ready for sale. While set up time is minimal, this method creates various problems. First, the half pallet display is a bulky item and is hard to maneuver down crowded aisles in a retail store, especially if an individual is not particularly skilled in using a hand truck. Second, since the product is shipped only through the display, there is no efficient way to replenish the product. Finally, when the display is no longer needed, it must be broken down. Since much of the material is not reusable, most of it is discarded.

One aspect of this invention is to provide a method of packaging, shipping, stocking, and displaying retail products in an efficient manner that reduces overall set up, take down, and handling time, uses less material, and costs less to ship.

### SUMMARY OF INVENTION

A quick assembly retail product display system of this invention provides many features that afford retailers with a system that efficiently displays retail products while maximizing the promotional means needed to sell a retail product. The display system includes a rack, multiple display trays, clips used to mount the display trays to the rack, and graphic components. Retail product is packaged and shipped within the display trays, allowing the display trays and product to be put on display without removing the retail product from the trays. Clips are removably mounted to the rack, which allows for multiple configurations of the display system. The rack portion of the display system can be quickly set up and is collapsible when not being used to display retail product, taking up a fraction of its display space. Additionally, the rack is easily movable, allowing the rack to be placed in many different locations. The graphic components provide advertising space, and can come in variety of shapes and sizes to enhance the appearance of the display system.

### BRIEF DESCRIPTION OF DRAWINGS

FIG. 1 is a perspective view of a retail product display system according to one embodiment of this invention.

FIG. 2 is another perspective view of the retail product display system from FIG. 1.

FIG. 3 is a perspective view of a retail product display system with a chair back riser according to one embodiment of this invention.

FIG. 4 is a perspective view of a display tray of the system of FIG. 1.

FIG. 5 is a perspective back view of the display tray of FIG. 4.

FIG. 6 is a schematic view of a blank for forming the display tray of FIG. 4.

FIG. 6a is a partial view of the blank of FIG. 6.

FIG. 7 is a perspective view of an easel of the display tray of FIG. 4.

FIG. 8 is a perspective view of the easel of FIG. 7.

FIG. 9 is a perspective view of the easel of FIG. 7.

FIG. 10 is a perspective view of a tilting mechanism and display tray of FIG. 4.

FIG. 11 is a perspective view of a display tray and a wedge according to one embodiment of this invention.

FIG. 12 is a perspective back view of the wedge of FIG. 10.

FIG. 13 is a perspective front view of the wedge of FIG. 11.

FIG. 14 is a schematic view of a blank for forming the wedge of FIG. 11.

FIG. 15 is a perspective view of a display tray and a product retainer according to one embodiment of this invention.

FIG. 16 illustrates a blank for forming a product retainer according to one embodiment of this invention.

FIG. 17 is a perspective view of a rack according to one embodiment of this invention.

FIG. 18 is a perspective view of the rack of FIG. 17 in a collapsed position.

FIG. 19 is a perspective view of a bracket according to one embodiment of this invention.

FIG. 20 is a perspective view of a sliding channel according to one embodiment of this invention.

FIG. 21 is a perspective view of a slide plate according to one embodiment of this invention.

FIG. 22 is a perspective view of a portion of the rack of FIG. 17.

FIG. 23 is a perspective view of a rack according to one embodiment of this invention.

FIG. 24 is a perspective view of the rack of FIG. 23.

FIG. 25 is a front perspective view of a clip according to one embodiment of this invention.

FIG. 26 is a back perspective view of the clip of FIG. 25.

FIG. 27 is a perspective view of a clip and a partial view of a rack according to one embodiment of this invention.

FIG. 28 is a perspective view of a display tray with the clip and rack of FIG. 27.

FIG. 29 is a perspective side view of the display tray, clip and rack of FIG. 28.

FIG. 30 is a front perspective view of the display tray, clip, and rack of FIG. 27.

FIG. 31 is a perspective view of a riser according to one embodiment of this invention.

FIG. 32 illustrates a blank for forming a riser according to one embodiment of this invention.

FIG. 33 illustrates a blank for forming a riser according to another embodiment of this invention.

FIG. 34 illustrates a partial perspective top inner view of the assembled riser of FIG. 33.

FIG. 35 is a front perspective view of a chair back riser according to one embodiment of this invention.

FIG. 36 is a back perspective view of the chair back riser of FIG. 35.

FIG. 37 illustrates a blank for forming a chair back riser according to one embodiment of this invention.

FIG. 38 is a front perspective view of a corner graphic according to one embodiment of this invention.

FIG. 39 is a back perspective view of the corner graphic of FIG. 38.

FIG. 40 illustrates a blank for forming a corner graphic according to one embodiment of this invention.

FIG. 41 is a front perspective view of a corner graphic according to another embodiment of this invention.

FIG. 42 is a back perspective view of the corner graphic of FIG. 41.

FIG. 43 illustrates a blank for forming the corner graphic of FIG. 41.

FIG. 44 is a perspective front view of a back graphic according to one embodiment of this invention.

FIG. 45 illustrates a blank for forming a back graphic according to one embodiment of this invention.

FIG. 46 is a flow diagram showing a method for shipping and displaying retail products by a retailer according to one embodiment of this invention.

### DETAILED DESCRIPTION

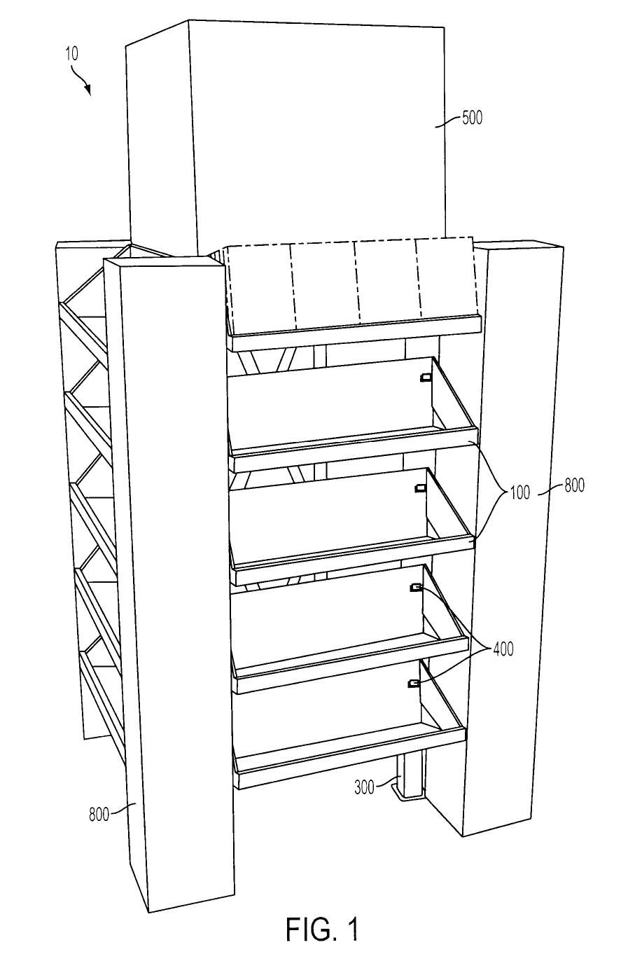

Quick assembly display systems 10 according to embodiments of this invention may be used to quickly and efficiently display retail product. As illustrated in FIGS. 1-3, one embodiment of the quick assembly display system 10 may include display trays 100, a display rack 300, clips 400, and graphic display components 500, 700, 800, and 900. The retail product may be housed and shipped within the display trays 100 prior to assembly of the display system 10. When the product filled trays 100 are received at the retail location, the display rack 300 may be easily moved to the desired display location and expanded. The graphic display components 500, 700, 800, and 900, which provide multiple surfaces for advertisement, may then be assembled onto the display rack 300. The display trays 100 may be mounted to the display rack 300 using clips 400, reducing stocking and assembly time. No additional display material is required and much of the shipping material is used for display is recyclable. Components of the system are described in detail below.

### The Display Tray

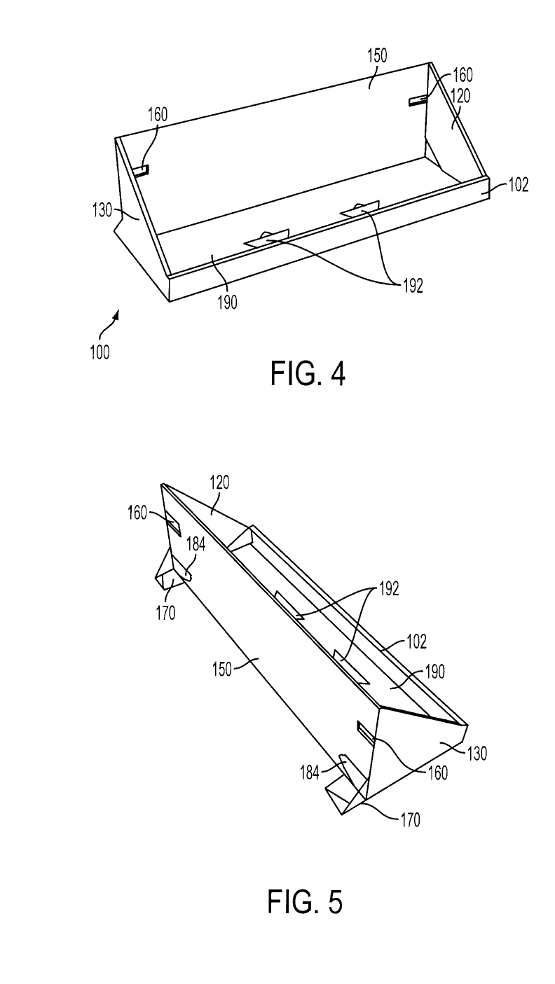

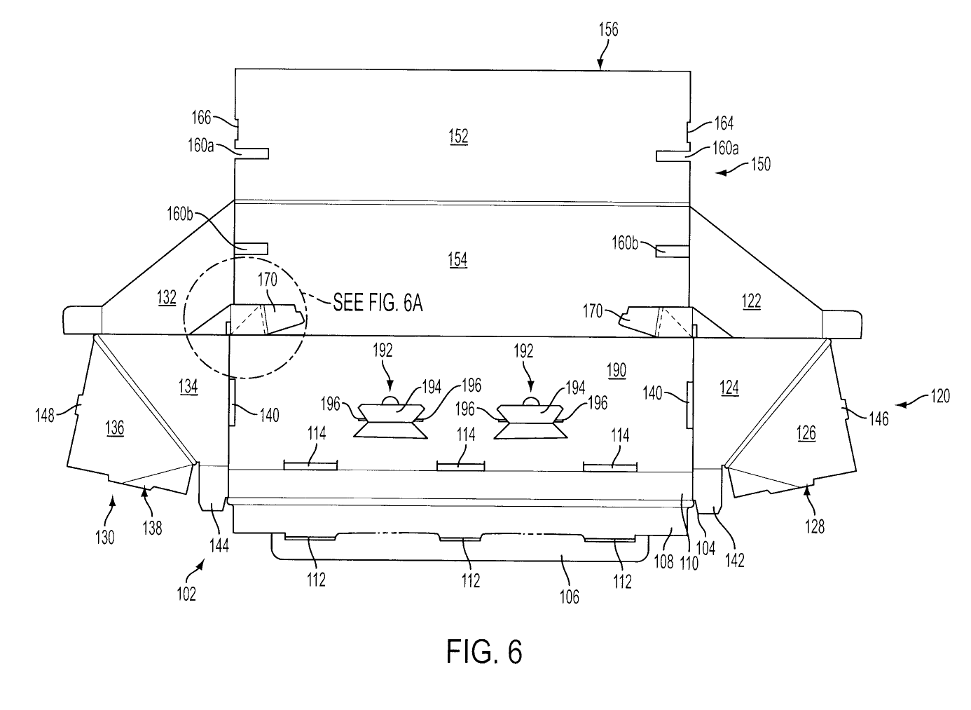

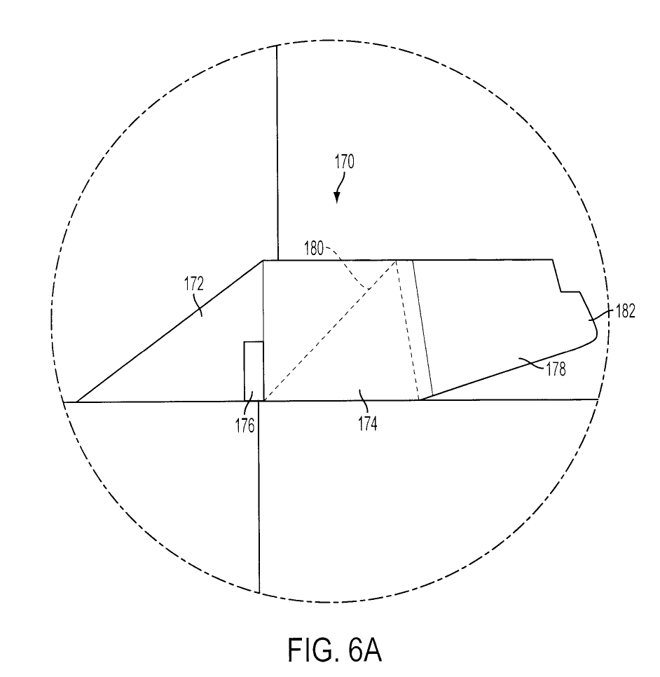

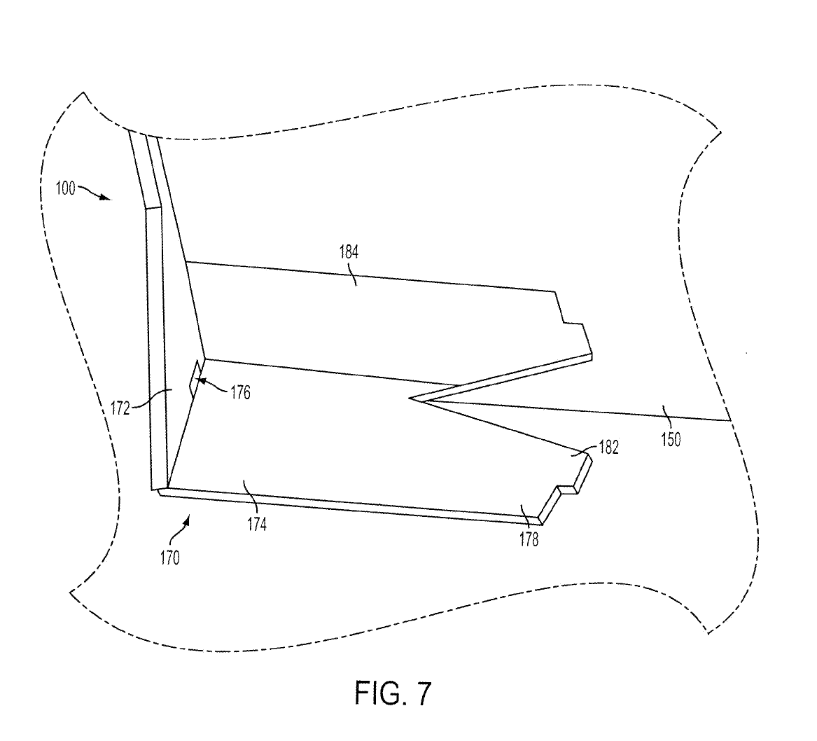

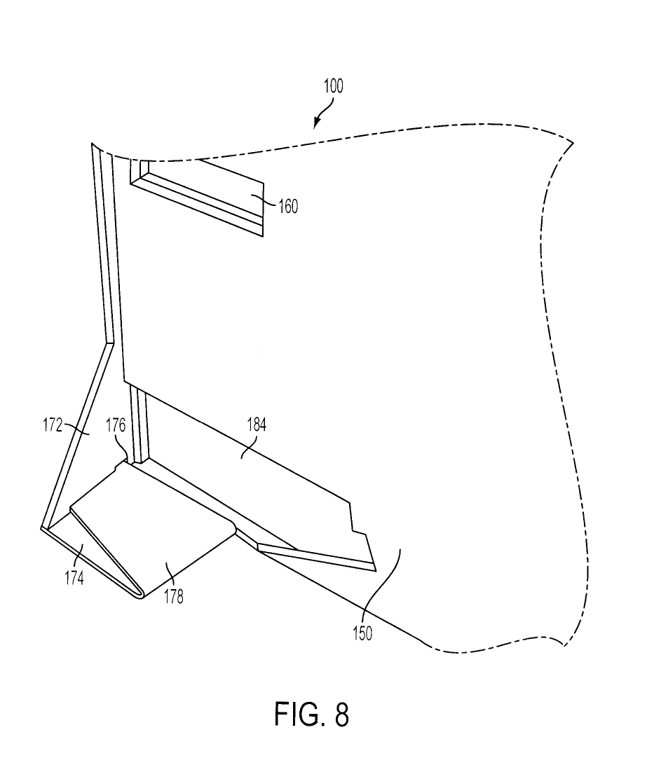

FIGS. 4-10 illustrate a display tray 100 according to one embodiment of this invention. As discussed above, retail product is shipped and displayed in tray 100, reducing assembly time and decreasing material costs. The display tray 100 may include a front lip 102, two peripheral walls 120 and 130, a back wall 150, and a bottom 190. The tray 100 may also include easels 170 and a tilting mechanism 192 used to improve product visibility. The display tray 100 may be formed from a continuous sheet of corrugated material, as shown in FIG. 6, or from any other suitable material. The tray portions may be secured through mechanical means, or may be adhered together.

The height of the lip 102 is less than the height of the back wall 150, so that the retail products are retained in the tray 100 but are visible from the front of the tray 100. The lip 102 may be comprised of a solid tab 104 that extends from the bottom 190 of the tray 100. In one embodiment, tab 104 includes three folded portions 106, 108, and 110, providing a thickness that increases the stability of the lip 102. The first fold 106, which is not as wide as the other folded sections, is held between the second 108 and third 110 folded sections, creating space between the second 108 and third 110 folded sections to receive tabs. The second fold 108 has three protrusions 112 that may be inserted into three respective slots 114 formed within the fold between the lip 102 and the bottom 190, to retain the lip 102 in position. However, any other suitable retaining means may be used to secure the lip 102. While the lip 102 of FIGS. 4-6 is rectangular, the lip 102 may be of any shape that permits retention of the retail goods while providing good product visibility.

The peripheral walls 120 and 130 of the tray 100 are connected to the lip 102, the back wall 150, and the bottom 190. The walls 120 and 130 extend from the top of the lip 102 to the top of the back wall 150, increasing the stability of the tray 100. The construction of the peripheral walls 120 and 130 prevents the walls from tearing under the weight of the retail products when the tray 100 is connected along its back wall 150 to the display rack 300. Each peripheral wall 120 and 130 includes two extensions 122, 124 and 132, 134, respectively. Each first extension 122, 132 is connected to the back wall 150 and is folded towards the lip 102, while each second extension 124, 134 is connected to the bottom 190 and is folded upwards. Each second extension 124, 134 includes a foldable portion 126, 136, which is folded cross-diagonally over the first portion 122, 132. The foldable portion 126, 136 includes a tab 128, 138, which is received in a slot 140 to secure the peripheral wall 120, 130.

Tab ends 142 and 144 at the front edge of the peripheral walls are inserted between the folded portions 106, 108, and 110 of the lip 102, connecting the lip 102 and the peripheral walls 120 and 130. Tabs 138 and 148 extend from the foldable portions 126 and 136 and are received in slots 164 and 166 of the back wall to secure the peripheral walls 120 and 130 to the back wall 150.

The tray bottom 190 is comprised of one layer and is foldably connected to all of the walls of the display tray 100. Slots 114 in bottom 190 receive tabs 112 to secure the lip 102. Slots 140 adjacent the peripheral walls 120, 130 receive tabs 146 and 148 to secure the walls 120, 130. Additionally, the bottom 190 may include a tilting mechanism 192, described in detail below.

The back wall 150 is the tallest wall of the display tray 100 and prevents the product from falling out of the back of the tray 100 when shipped and displayed. The display tray 100 is tilted back slightly when mounted to the display rack 300, described further below, and the retail product rests against the inside surface of the back wall 150. The back wall 150 is formed from a first portion 152, which is folded against a second portion 154. An edge 156 of the first portion 152 contacts the bottom 190. In an alternate embodiment, the first portion 152 may include three protrusions on its lower edge that are inserted into three respective slots formed within a fold between the bottom 190 and the back wall 150, securing the first portion 152 and thus the two layers 152 and 154 forming the back wall.

Two slots 160, formed along the top portion of the back wall 150 near the respective peripheral walls 120 and 130, extend through both portions 152 and 154 of the back wall, each portion 152 and 154 having slots 160a and 160b that align together into one slot 160. The slots 160 receive the clips 400 to retain the display tray 100 on the display rack 300, as further described below. The easels 170 may be housed within easel cutouts 184 of the back wall 150 during shipment, also described below.

Retractable easels 170, shown in FIGS. 5-9, are used to increase product visibility and to prevent product from falling out of the tray 100. The easels 170 extend from the back wall 150 adjacent to the bottom 190. When the easels 170 are extended, they push against the display rack 300, tilting the tray 100 and lifting slightly lip 102. In one embodiment, two easels 170 are used, but any suitable number of easels may be used.

The easels 170 include a vertical portion 172 and a horizontal portion 174. The vertical portion 172 is connected to a lower portion of the peripheral wall 130 and the horizontal portion 174 of the easel, forming a triangle between the horizontal portion and the peripheral wall 130, as shown in FIGS. 5-9. The horizontal portion 174 is cut-out from the back wall 150, creating an easel cutout 184. The horizontal portion 174 is partially connected to an edge of the bottom 190. The rest of the horizontal portion 174 is not connected, leaving a free end 178. A tab 182 extends from the free end 178 of the horizontal portion 174. When the easel 170 is activated, the free end 178 is folded towards the vertical portion 174, the free end 178 reinforcing the easel 170. The tab 182 of the free end 178 is received in the slot 176 in vertical portion 172 to reinforce the easel 170.

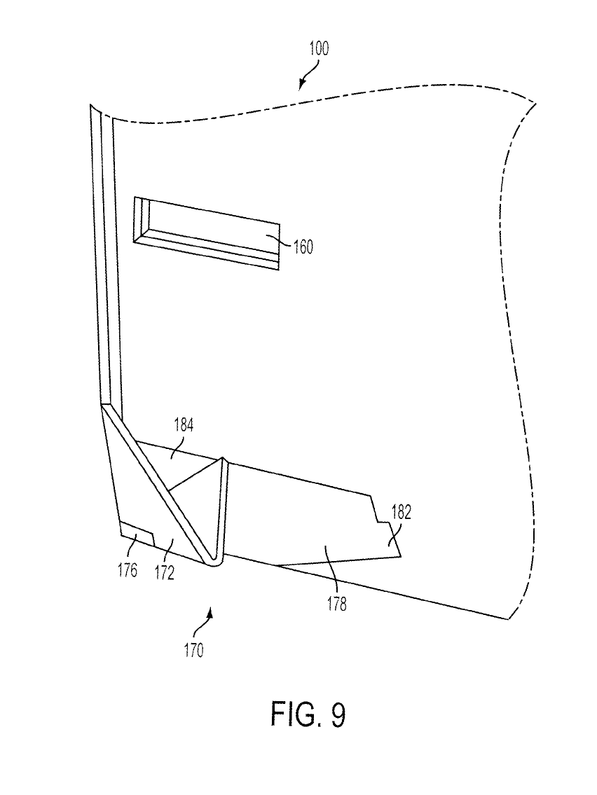

The easels 170 may be retracted into the easel cutout 184 for shipping as shown in FIG. 9, preventing potential damage and allowing for more compact shipping. The free half 178 of the horizontal portion 174 is folded against the back wall 150 and received in the easel cutout 184. A scored fold 180 across the horizontal portion 174 allows the vertical portion 172 to be folded towards the back wall 150 without damaging any portion of the easel 170.

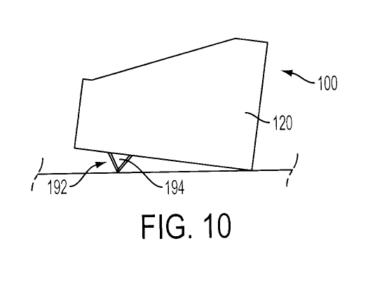

In one embodiment, the tray bottom 190 includes a tilting mechanism 192 which may be used when the tray 100 is on display without the display rack 300. The tilting mechanism 192 is formed from a cut-out portion 194 of the bottom 190. In order to activate the tilting mechanism 192, the cut-out portion 194 is pulled downward and is partially folded towards the lip 102. The free end of the cut-out portion 194 is inserted into slots 196 and 197, securing the cut-out portion 194 in a folded position. As shown in FIG. 10, the cutout portion 194 extends below the bottom 190, tilting the lip 102 upward and helping retain the products within the tray 100.

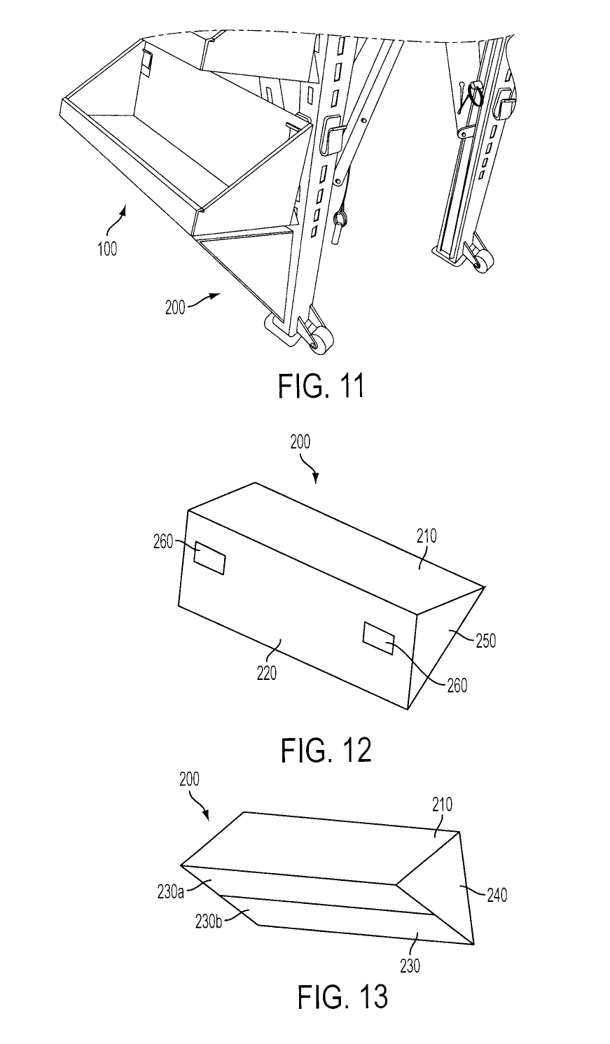

As shown in FIGS. 11-14, a wedge 200 may be provided for the display trays 100 that are placed at the bottom of the rack 300. The wedge 200 provides additional support for these bottom display trays 100 in the event that someone steps on or places their weight on the tray 100. The wedge 200 is attached to the display rack 300 underneath a display tray 100 and distributes much of the force away from the back wall 150 and peripheral walls 120 and 130.

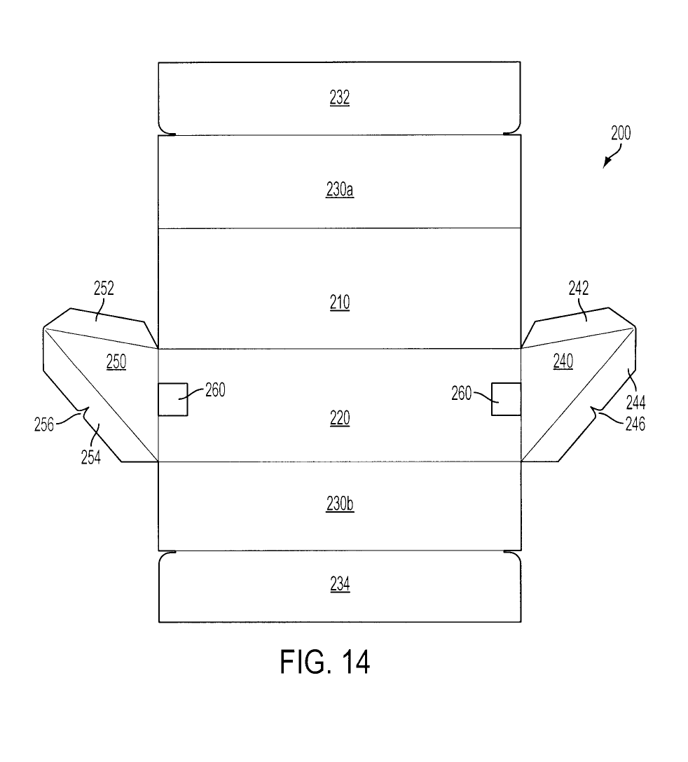

The wedge 200 includes five visible exterior surfaces: a top 210, a back 220, a face 230, and two side surfaces 240 and 250. Openings 260 of the back surface 250 allow the wedge 200 to engage clips 400 connected to the rack 300. The wedge 200 may be formed from a single blank, as shown in FIG. 14. The top surface 210 extends from the back surface 220. The side surfaces 240 and 250 also extend from the back surface 220. Tabs 242, 244 and 252, 254 extend from and are used to secure side surfaces 240 and 250. The face surface 230 is formed from a top face portion 230a and a bottom face portion 230b. The top face portion 230a extends from the top surface 210, while the bottom face portion 230b extends from the back surface 220. Securing tabs 232 and 234 may extend from the top and bottom face portions 230a and 230b. The securing tabs 230c and 230d of the top and bottom face portions 230a and 230b interact with the side surface tabs 242, 244 and 252, 254 respectfully when the wedge 200 is formed.

To form the wedge 200, side surfaces 240 and 250 are folded away from the back surface 220 at a 90° angle. The tabs 242, 244, and 252, 254 of the side surfaces 240 and 250 are folded inwardly. The top surface 210 is folded away from the back surface 220 and rests against the top tabs 242 and 252 of the side surfaces 240 and 252. The top face portion 230a is then folded to rest against part of the bottom tabs 244 and 254 of the side surfaces 240 and 250. The securing tab 232 connected to the top face portion 230a is folded and inserted into slots 246 and 256 of the bottom tabs 244 and 254. The bottom face portion 230b is folded upwards to rest against the bottom tabs 244 and 254. The securing tab 234 of the bottom face portion 230b is folded and inserted into the slots 246 and 256 to secure the face surface 230.

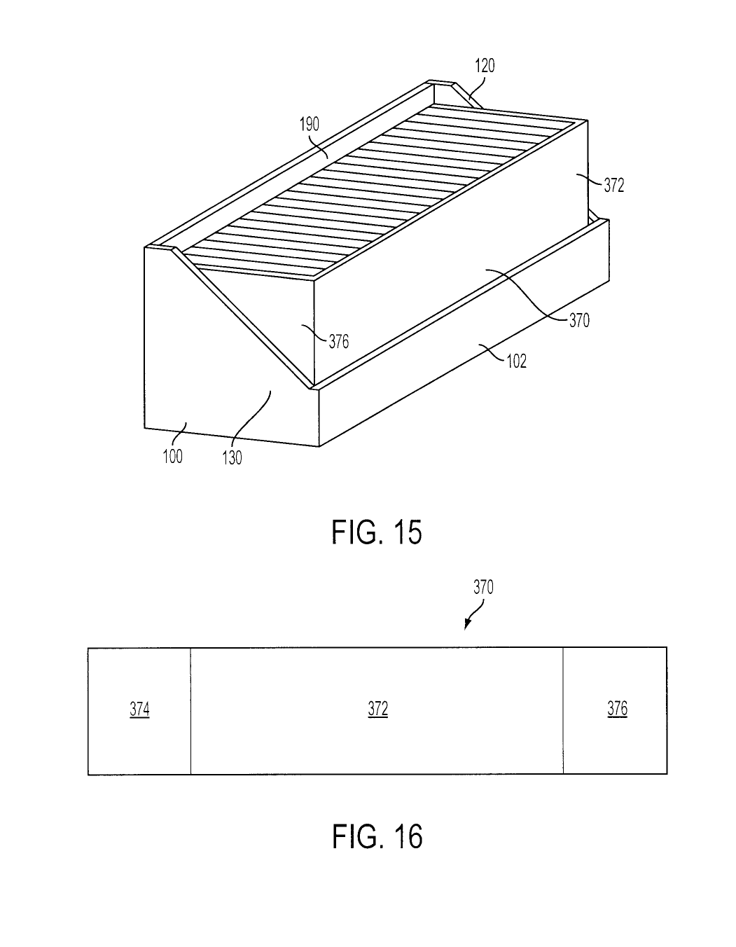

To assist in preventing retail product from falling out of the display tray 100 while being shipped, a product retainer 370 may be inserted into the tray 100 as shown in FIGS. 15-16. The product retainer 370 may be divided into three sections, a front section 372 and two side sections 374 and 376. When inserted, a bottom portion of the front section 372 of the product retainer 370 rests against the lip 102 of the display tray 100, while the two side sections 374 and 376 are adjacent to the peripheral walls 120 and 130 of the display tray 100. Once the display trays 100 loaded with product have reached their destination, the product retainer 370 may be removed, leaving the display tray 100 ready for inclusion in the display system 10.

### The Display Rack

The display rack 300 provides advantages over existing display systems. First, the rack 300 provides numerous display options and includes variable settings, allowing retail products to be placed and displayed in a variety of locations and levels. Second, the size of the rack 300 is adjustable, allowing the merchandiser to fit the rack into a range of different areas. Further, when fully collapsed, the rack may be easily stored. In some embodiments, a collapsed rack may take up less than one square foot.

Further, the rack 300 is portable, allowing merchandisers to easily transport the rack from place to place. Additionally, the rack may be composed of a sturdy material, such as metal like steel or aluminum, increasing the durability and stability of the rack and allowing repeated use, thereby reducing replacement costs.

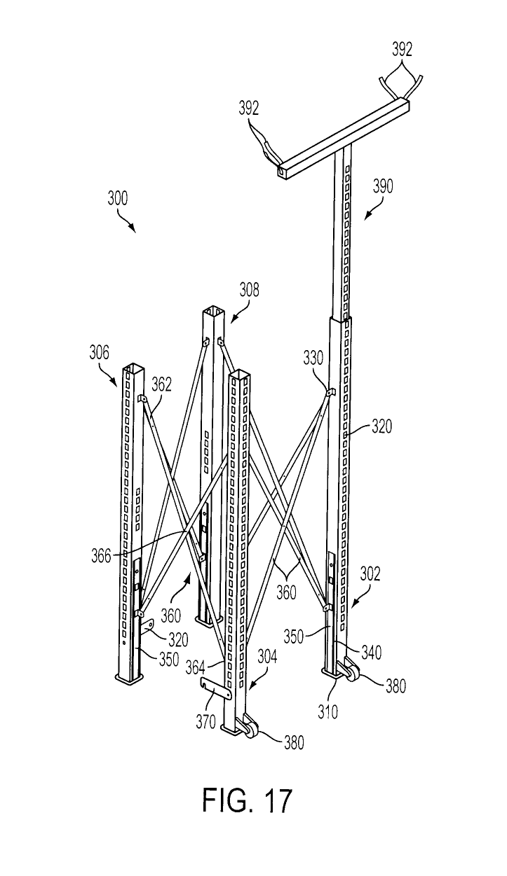

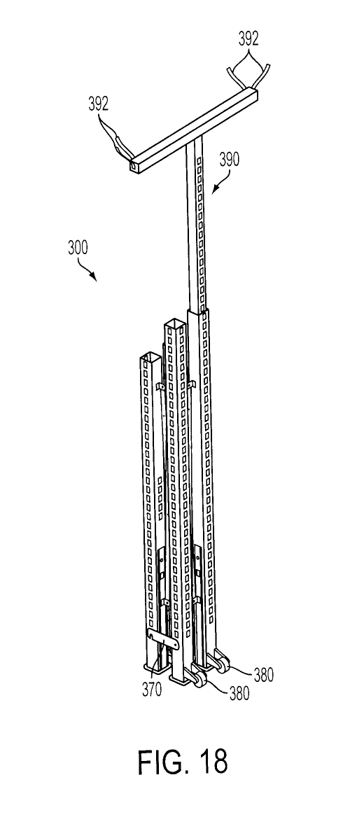

In one embodiment, shown in FIGS. 17-18, the rack 300 includes vertical support members. The illustrated embodiment includes four vertical support members 302, 304, 306, and 308; however, any suitable number of support members may be used. The vertical support members may be formed from metal, aluminum, or any other suitable sturdy and durable material. In one embodiment, the vertical support members are hollow tubes, having openings at the top and bottom ends. Utilizing hollow tubes eliminates unnecessary weight, which increases portability but does not compromise the structural integrity of the rack 300. The hollow tubes also provide other advantages, such as allowing clips 400 and other devices to easily mount to the vertical support members.

The vertical support members may be of various shapes and may also vary in length. In the embodiment shown in FIGS. 16-17, the vertical support members comprise rectangular hollow tubes 302, 304, 306, and 308 having four surfaces. Each tube 302, 304, 306, and 308 is arranged to place two surfaces facing outward with the remaining two surfaces facing another surface of another tube. These outward facing surfaces have a plurality of uniform cutouts 320 spaced evenly along their respective surfaces. The cutouts 320 receive clips 400, which engage the display trays 100 and side panels 800. A portion of a clip 400 is received in a cutout 320 and rests adjacent the inner surface of the housing. In one embodiment, numbers adjacent selected cutouts assist in assembling the trays 100 and clips 400 with the rack 300 in cases in which instructions have been given.

In one embodiment, a plurality of cutouts 320 on the inward facing surfaces of the vertical support members 302, 304, 306, and 308 provide storage for additional clips 400. These storage cutouts are generally located toward the middle of the vertical support members. In other embodiments, the inward facing surfaces may not include storage cutouts. In a preferred embodiment, the inward facing surfaces have areas near the top and bottom of the tube void of any cutouts.

In certain embodiments, a foot plate 310 may be added to the bottom of the tubes to provide a steady base. The foot plate 310 may be welded to the bottom of the tube to prevent the foot plate 310 from falling off while moving the rack. However, other means of attachment may be used.

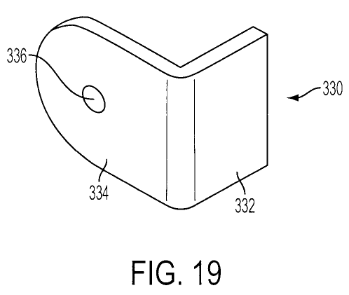

As shown in FIGS. 17-19, L-shaped mounting brackets 330 are located along the top end of each inwardly facing surface and include a base 332 and an arm 334 that extends from the edge of the base 332 at a right angle. The base portion 332 is coupled to one of the inwardly facing surfaces of the tubes with the arm 334 aligned vertically. In one embodiment, the mounting bracket 330 is welded to a tube. However, other securing means, including, but not limited to, bolting, may be used to mount the bracket. The arm portion 334 of the mounting bracket 330 has an aperture 336 which receives a bolt to attach a cross beam 360, discussed further below.

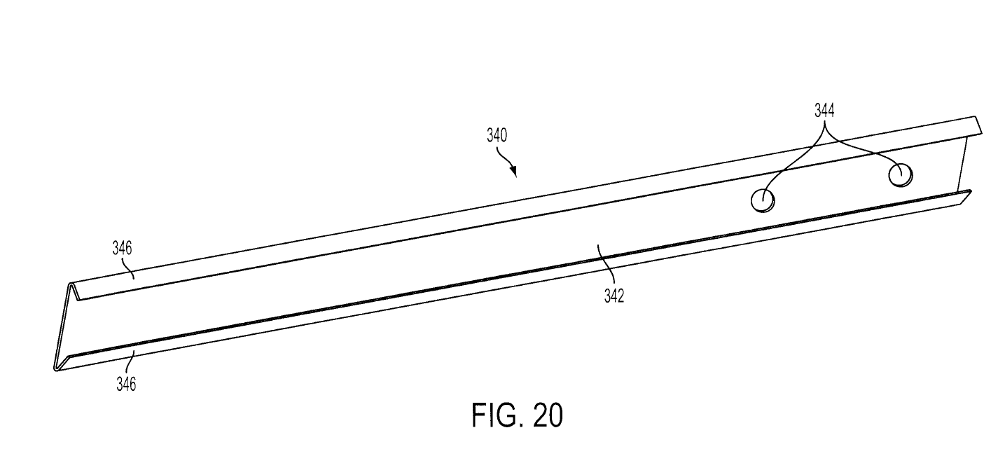

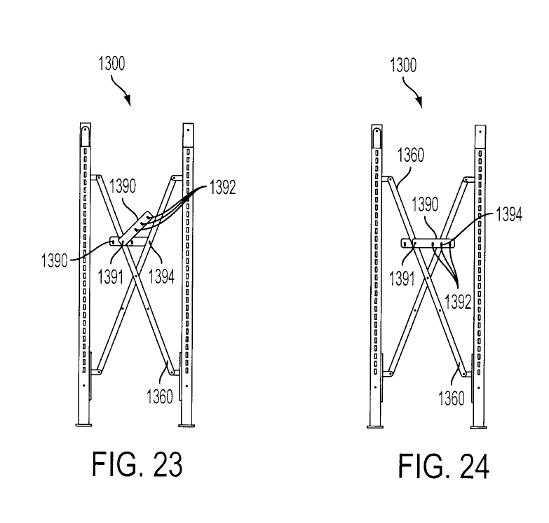

As shown in FIGS. 20 and 23, each vertical support member may include a sliding channel 340 that includes a flat portion 342 and apertures 344. The flat portion 342 may be welded or bolted to the bottom of the inwardly facing surfaces of the vertical support members. The lower portions of the inner surfaces include corresponding apertures (not shown) which are aligned with the apertures 344 of the sliding channel 340. However, in one embodiment, the slide channel does not include apertures. As illustrated in FIG. 20, folded portions 346 extend from the side edges of the flat portion 342 at an angle less than 90 degrees. In one embodiment, the folded portions 346 form a 30 degree angle with the flat portion 342.

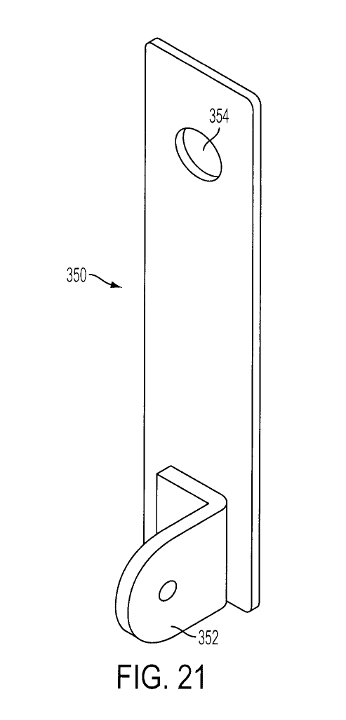

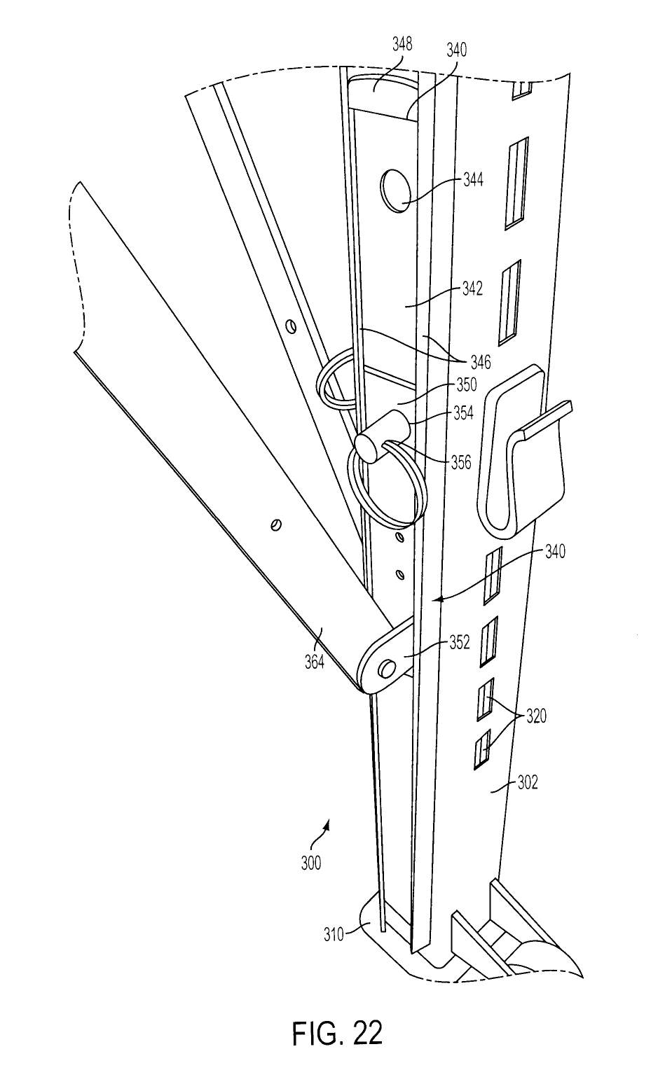

As shown in FIGS. 21-22, a sliding plate 350 is received in the sliding channel 340 and is retained in the channel 340 by folded portions 346. Sliding plate 350 slides vertically within the channel 340 when the rack is either expanded or collapsed, as further described below. An L-shaped mounting bracket 352, similar to the mounting brackets 330 discussed previously, may be attached at the bottom of the sliding plate 350 to receive a cross brace 360. In one embodiment, the mounting bracket 352 is welded flush with a bottom edge of the sliding plate 350. In an alternative embodiment, the slide plates 350 include other means to receive a cross support brace end.

As shown in FIGS. 21-22, the sliding plate 350 includes aperture 354 that corresponds to the apertures 344 in the flat portion 342 of the sliding channel 340. An insert 356 such as a clevis pin may be inserted through the sliding plate aperture 354 and into one of the plurality of apertures 344 of the channel 340 and the apertures (not shown) of the vertical support members 302, 304, 308, and 310, preventing movement of the sliding plate 350. The inserts 356 must fit tightly with the apertures 344 and 354 to prevent further expansion or retraction of the rack 300. When not inserted, the inserts 356 may be secured to various parts of the rack through the use of wire or cable ties. Hardware, such as a stopper 348, may be installed at the top end of the sliding channel 340 to prevent over travel of the sliding plate 350. In other embodiments, a stopper may be placed at the bottom end of the channel 340.

As shown in FIG. 17, a plurality of cross beams 360 are attached to the tubes 302, 304, 306, and 308 to provide support for and guide expansion and retraction of the rack 300. The cross beams 360 have an upper end 362, a lower end 364, and a middle portion 366. A hole adapted to receive a bolt or some other fastening device may be found in each end (not shown), as well as a middle portion 366 of the cross beam 360. Two cross beams 360 are used between two adjacent tubes, as shown in FIG. 17. The cross beam 360 may be attached to one of the mounting brackets 330 found at the top edge of a first tube 302 and to the sliding brackets 352 of the sliding plate 350 of the second tube 308. Another cross beam 360 is attached to the mounting bracket 330 of the top edge of the second tube 308 and to the sliding mounting bracket 352 of the sliding plate 350 of the first tube 302. The two cross beams 360 cross each other at their middle portions 366 of the cross beams. A nut and bolt may be inserted into the hole found at the middle portions 366 of the cross beams 360 to connect them together.

The construction and interaction of the components above allow the rack 300 to be collapse and expand. When the rack 300 is fully extended, the sliding plate 350 is located at its apex position within the sliding channel 340. To collapse the rack 300, the inserts 356 restricting the vertical movement of the sliding plate 350 are removed. As the tubes 302, 304, 306, and 308 move toward each other, the cross beams 360 pivot about their respective mounting brackets 330 and 352. With the top mounting brackets 330 in a static position along the inner surfaces of the tubes, the mounting bracket 352 mounted on the sliding plate 350 forces the sliding plate 350 to move in a downward direction within the sliding channel 340. The cross braces 360 move in a scissor-like motion in relation to one another, with all ends 362 and 364 of the braces moving closer to one another. As this is done, all of the tubes 302, 304, 306, and 308 move towards each other, collapsing the rack 308.

To expand the rack 300, the tubes 302, 304, 306, and 308 are moved away from each other, and the sliding plates 350 move in an upward direction within the sliding channel 340. When the rack 300 has reached the desired expansion size, the inserts 356 may be inserted through the apertures 354 in the sliding plates 350 into the appropriate apertures 344 in the sliding channel, securing the rack at the desired size.

In an alternative embodiment, locking brackets 1390 mounted to the cross support braces 1360 are used to arrest the expansion and retraction of the rack 1300, rather than apertures and inserts associated with the sliding channel and plate. As shown in FIGS. 23-24, an aperture 1391 located near one end of the locking bracket 1390 allows the locking bracket 1390 to be pivotally mounted to one cross support brace 1360. A number of locking holes 1392 are distributed across the locking bracket 1390 opposite the aperture 1391. The locking holes 1392 receive a locking peg 1394 located on cross support brace 1360 to which the locking bracket 1390 is not mounted. The multiple locking holes 1392 allow for a variety of sizes for the rack 1390. During expansion of the rack 1300, the locking holes 1392 are free of the locking peg 1394. Once the desired size of the rack 1300 is reached, the locking peg 1394 is inserted into the corresponding locking hole 1392, preventing the cross support braces 1360 from moving.

When in a collapsed position, as shown in FIG. 18, a latch 370 may be used to prevent the rack 300 from expanding. In one embodiment, a latch 370 is permanently mounted on a first vertical support member, and removably locks an adjacent vertical support member to the first support member.

The racks 300 may also include casters 380 mounted to the bottom of an outward facing surface of two tubes 302 and 304, facing the same direction. These casters 380 help in transporting the rack 300 when it is in the collapsed position. In one embodiment the casters 380 are retractable as one of skill in the art would know. This allows the casters 380 to be hidden when the display system 300 is in the public view, and eliminates the need of any cutouts along the rear graphic display 900, discussed in more detail below. Additionally, in some embodiments the casters 380 are removable, and may be removed when the rack 300 is on display. In one embodiment, the two adjacent tubes 302 and 304 on which the casters 380 are longer in length than the two remaining tubes 306 and 308. The top end of the longer tubes 302 and 304 may be used as handles when moving the rack 300 using its casters 380.

In one embodiment, the rack 300 includes a retractable post 390 used to display information on the top of the rack. When in use, the retractable post 390 extends upward beyond the ends of the vertical support members. The top end of the retractable post 390 includes protrusions 392 from which signs may hang. Other means of retaining signs, such as, but not limited to, clips, may also be used. The retractable posts 390 are connected to the top ends of the tubes of the rack 300 in a manner in which they may be retracted when not in use. In one embodiment, the bottom end of a retractable post 390 is pivotally connected to the vertical support member. When not in use, the post 390 is pivoted down and secured against the tubes. The post 390 may be connected with an adjustable wing nut or other means. In one embodiment, the poles may be telescopic as shown in FIG. 17. In another embodiment, the posts 390 are completely removable when not in use.

### Clip

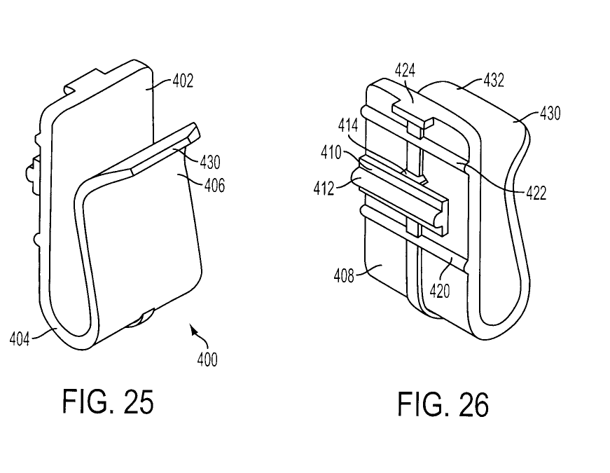

As described briefly above, clip 400 connects display trays 100, wedges 200, corner graphic segments 800 and back graphics 900 to the rack 300. As shown in FIGS. 25-26, the clip 400 is shaped like a hook, having a straight end 402 which continues into a curved portion 404, and extends into a free end 406 that runs substantially adjacent to the straight end 402. The clip 400 is semi-rigid, having some flexibility along the curved portion 404. The clip 400 must be made of a material with limited flexibility and very high resistance to breakage. The clip 400 may be formed from plastic, including polycarbonate, but other materials with similar properties, such as fiber resins, may be used.

The straight end 402 of the clip 400 connects the display tray 100 to the rack 300. A back surface 408 of the straight end 402 engages a front surface, of the rack 300, bearing the majority of the weight of the display tray 100 and the retail product the tray contains. As such, the straight end 402 is the thickest section of the clip 400. A T-shaped member 410, formed by a truss portion 412 supported by a leg 414, extends perpendicularly from the back surface 408 of the straight end 402 of the clip, with the truss portion 412 of the T-shaped member 410 running along the width of the straight end 402. The length of the truss 412 is shorter than the width of the straight end 402. However, the length of the truss 412 is larger than that of the width of the cutouts 320 of the rack, but shorter than the cutout's 320 length. The leg 414 of T-shaped member 410 has a height that is slightly greater than the thickness of the housing of the tubes 302, 304, 306, and 308 of the display rack 300. Additionally, the width and length of the leg 414 is less than the width of the cutout portions 320. The importance of these dimensions will be disclosed further below. Two ridges 420 and 422 run along the width of the back surface 408 with one ridge 422 above the T-shape member 410 and the other ridge 420 below the T-shape member 410. The ridges 420 and 422 engage a front surface 312 or 314 of the tubes of the display rack 300, further supporting the clip 400 and relieving the clip 400 from additional strain. A protrusion 424 along the top edge of the straight end 402 of the clip 400 is located parallel to the leg 414 of the T-shaped member 410.

The free end 406 of the clip extends upward from the curved portion 404 and towards the straight portion 402 until it turns away near the top of the free end, forming a rounded tongue portion 430. The free end 406 is not as thick as the straight end 402 nor the curved portion 404. The width of the free end 406 is equal to the width of the straight end 402. The inner surface of the free end 406 faces the inner surface of the straight edge 402, but the respective surfaces do not touch each other. The upper edge of the free end has a textured surface 432 to prevent the upper edges of the slots 160 of the display tray 100 from slipping from the grasp of the clip 400.

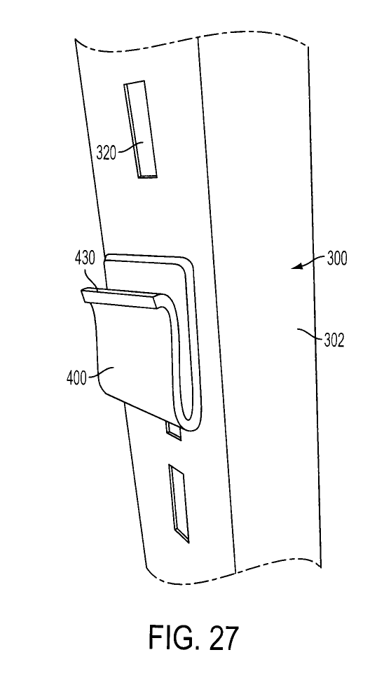

To attach the clip 400 to the tubes of the rack 300, the truss portion 412 of the T-shaped member 410 is inserted vertically into the desired cutout 320, and then rotated until the truss 412 is horizontal and the clip 400 is in the upright position. The underside of the truss portion 412 is adjacent the back surface of the housing of the vertical support member. The leg 414 of the T-shaped member 410 slides downward until it rests against the bottom edge of the cutout 320. The protrusion 424 along the upper portion of the straight end 402 engages the cutout 320, further securing the clip 400 and preventing the clip 400 from rotating, as shown in FIG. 27.

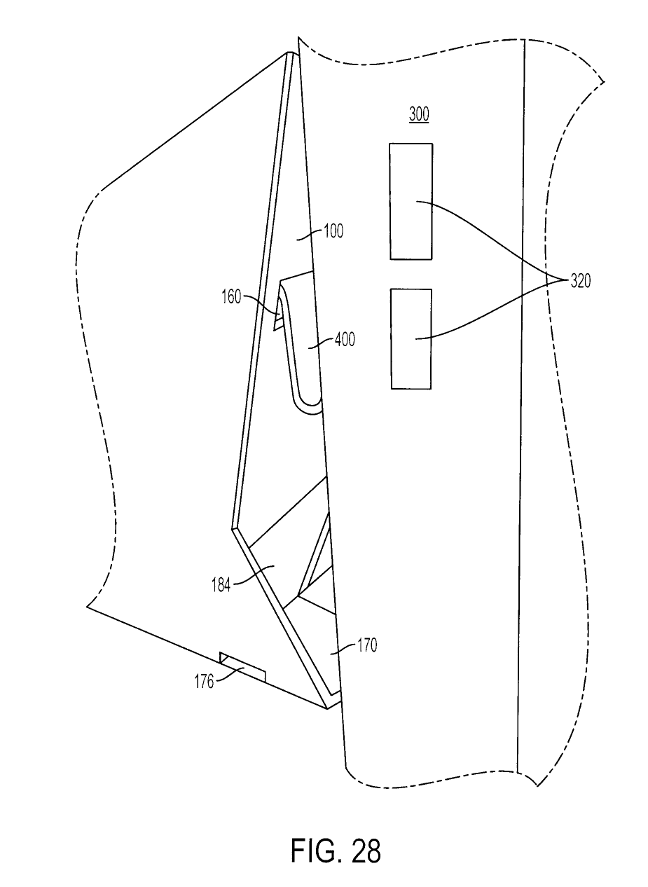

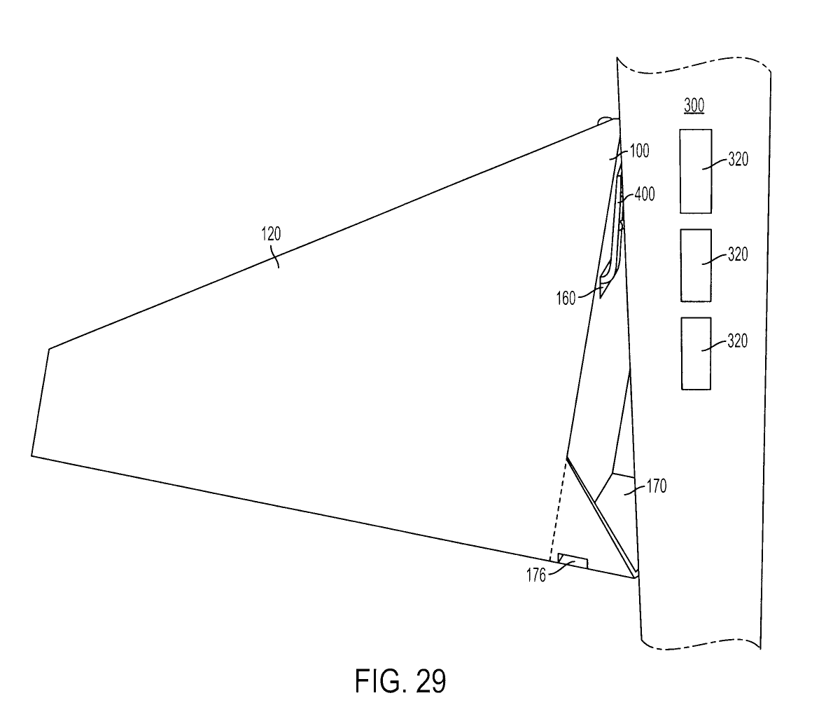

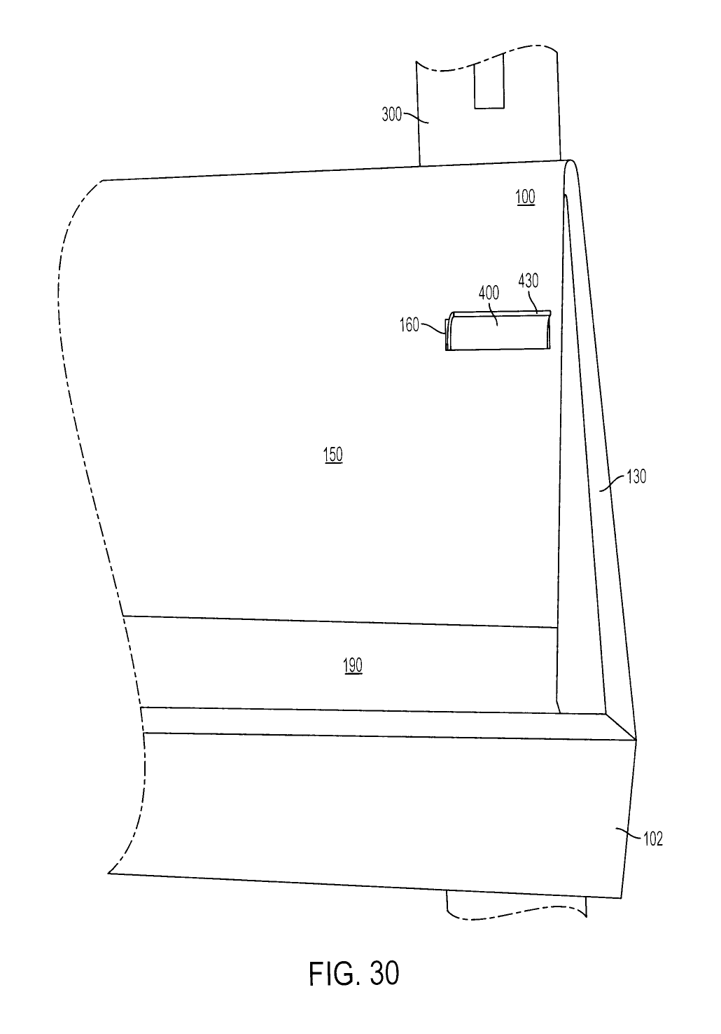

As shown in FIGS. 28-30, the display tray 100 is attached to the clip 400 by sliding the slots 160 of the back wall 150 onto the rounded tongue portion 430 of the clip 400 until the upper edge of the slot 160 of the back wall 150 rests upon the curved portion 404 of the clip 400. The inner surface of the free edge 406 presses against the visible surface of the back wall 150 to retain the display tray 100. The curved portion 430 assists in aligning the free end 406 of the clip 400 appropriately with the tilt of the tray 100 created by the easels 170.

### Graphic Display Components

The display system 10 may also use graphic display components to draw the interest of the consumer and provide information about the retail product. Such components may be located in various positions on the system.

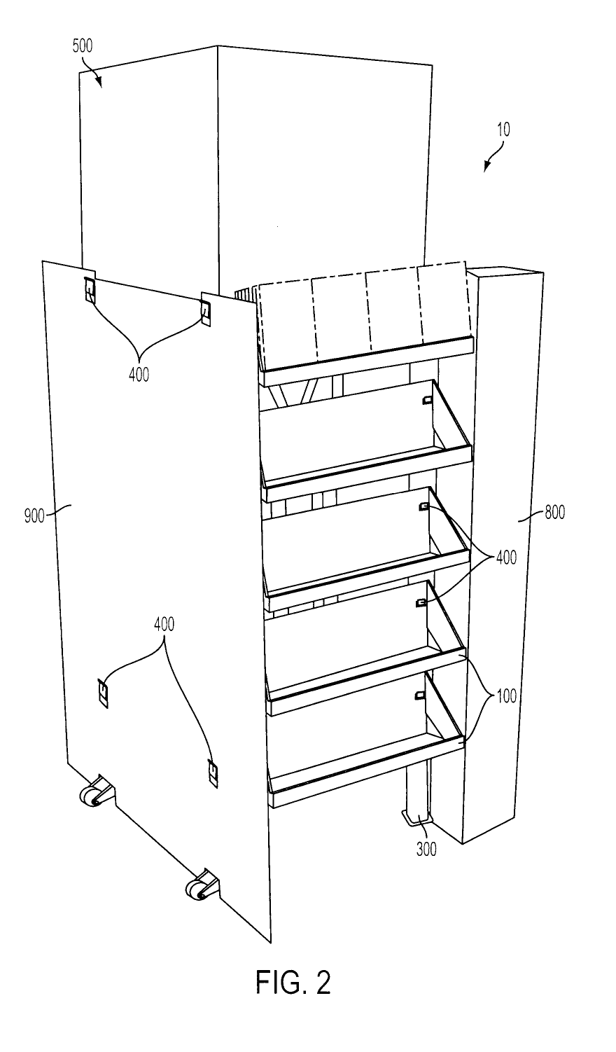

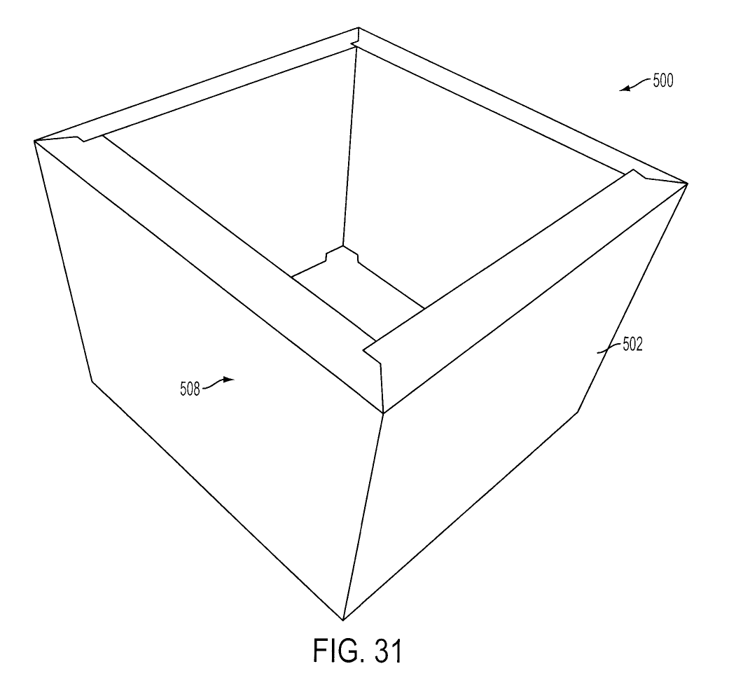

In one embodiment, the display system 10 includes a riser 500, shown in FIG. 31. As shown in FIGS. 1-2, the riser 500 may be placed on top of the rack 300 and is visible from all sides by a consumer, providing surfaces for information about the product. In one embodiment, the riser includes four vertical surfaces 502, 504, 506, and 508.

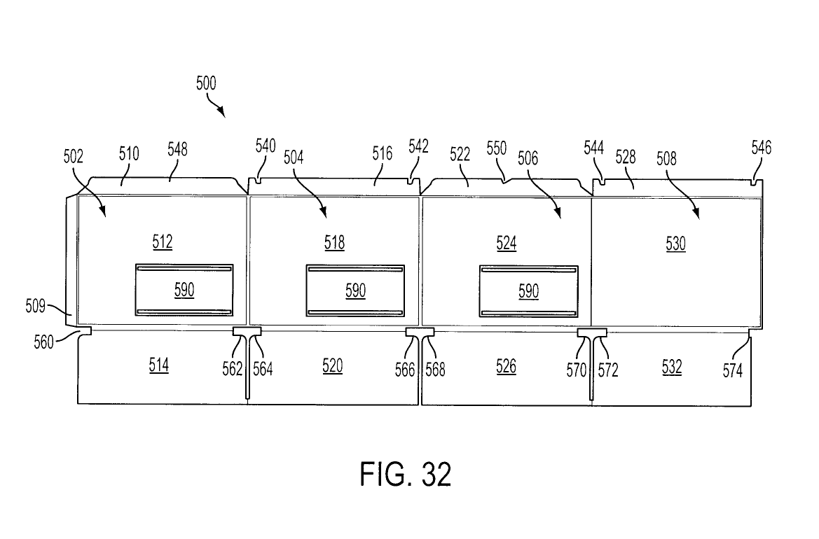

As shown in FIG. 32, the riser 500 may be comprised from a single corrugated sheet divided into four vertical sections 502, 504, 506, and 508 and a glue receiving section 509. Each vertical section 502, 504, 506, and 508 has a top portion 510, 516, 522, and 528, a middle portion 512, 518, 524, and 530, and a bottom portion 514, 520, 526, and 532. To form the riser 500, the corrugated sheet is folded into an incomplete box as shown in FIG. 31, with the four vertical sections 502, 504, 506, and 508 forming four sides, and the bottom portions 514, 520, 526, and 532 folded against the inner surface of the middle portions 512, 518, 524, and 530. The top portions 510, 516, 522, and 528 are folded horizontally to engage adjacent top portions. The glue receiving portion 509 is adhered to the last vertical section 508 to further secure the riser 500. In one embodiment, top portions 516 and 528 each include receiving slots 540, 542, and 544, 546 respectively. The top portions 510 and 522 include tabs 548 and 550 that are received by the receiving slots 540, 542 and 544, 546 respectfully, forming a horizontal inner ledge that stabilizes the riser 500.

The bottom portions 514, 520, 526, and 532 of the vertical sections 502, 504, 506, and 508 are used to stabilize the riser 500 as well as secure the riser 500 to the rack 300. Each bottom portion 514, 520, 526, and 532 is folded upwards until it lays flat against the back surface of middle portion 512, 518, 524, and 530 with which it shares a fold. The bottom portions may be glued to their respective middle portions. In addition, the bottom portions may further secure price channels 590. To assist in stabilizing the riser 500 upon the rack, notches 560, 562, 564, 566, 568, 570, 572, and 574 are located in each top corner of the bottom portions 514, 520, 526, and 532. Similar notches may be found in the bottom corners of the middle portions. When the bottom portions 514, 520, 526, and 532 are folded and adhered to the middle portions 512, 518, 524, and 530, the notches of each align with one another, forming notches in the assembled riser 500. When the riser 500 is placed on the rack 300, the notches align with the tubes 302, 304, 306, and 308 of the rack 300, allowing the riser 500 to sit securely on the rack 300.

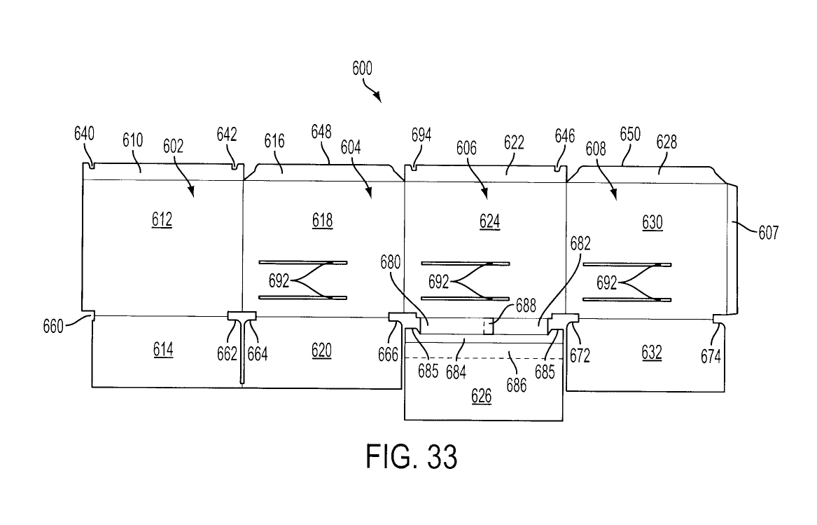

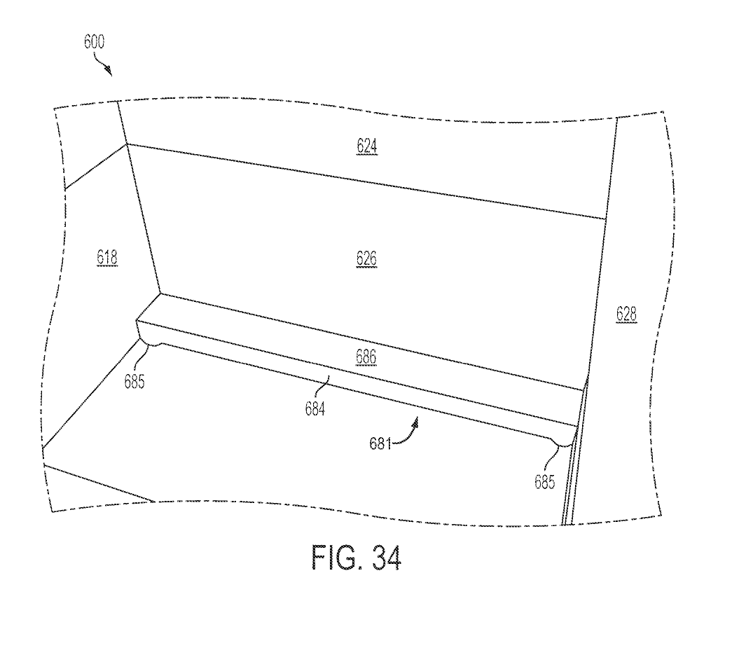

Another embodiment of a riser 600, shown in FIGS. 33-34 may be comprised from a single corrugated sheet divided into four vertical sections 602, 604, 606, and 608 and a glue receiving section 609. Each vertical section has a top portion 610, 616, 622, and 628, a middle portion 612, 618, 624, and 630, and a bottom portion 614, 620, 626, and 632. The blank is folded into an incomplete box as described above. Additionally, the riser 600 includes notches 660, 662, 664, 666, 672, and 674 that stabilize the riser 600 on the rack 300 as described above. In this embodiment, one of the bottom portions 626 is connected to the middle portion 624 by an extension 680. When the bottom portion 626 is folded to meet the back surface of the middle portion 624, the extension 680 forms a corrugated tube 681, as shown in FIG. 34.

The extension 680 is formed from three sub sections 682, 684, and 686. The sub section 682 connected to the middle portion 624 forms the bottom surface of the tube 681, while the sub section 686 connected to the bottom portion 626 forms a top surface of the tube 681. The remaining sub portion 684 forms a side surface of the tube 681. The sub portion 684 has protruding edges 685 that may be inserted into the tops of the vertical support members of the rack to further secure the riser 600. A tab 688 along the bottom surface 682 of the corrugated tube is folded into the corrugated tube 681, preventing the corrugated tube 681 from folding upon itself. The length of the tube 681 is equal to that of the distance between the vertical support members of the rack 300. When the riser 600 is placed on the rack 300, the corrugated tube 681 rests between two vertical support members. The corrugated tube 681 prevents the riser 600 from any shifting or pinching while it rests on top of the rack 300.

The middle portions of the vertical sections of both riser embodiments 500 and 600 are the only portions visible by the consumers when the risers 500 and 600 are placed on top of the rack 300. Extruded plastic price channels 590 used to retain sales information, as shown in FIG. 32, may be attached to the middle portions 502, 504, and 506. In one embodiment, the price channels may be formed within the middle portions by providing slots 692 that run in a horizontal direction and that retain price cards.

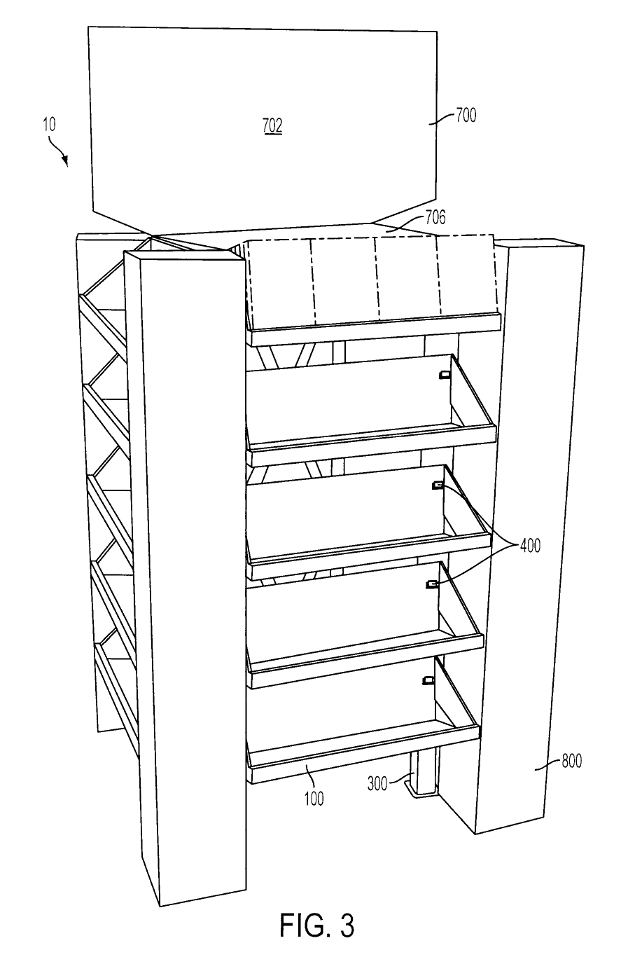

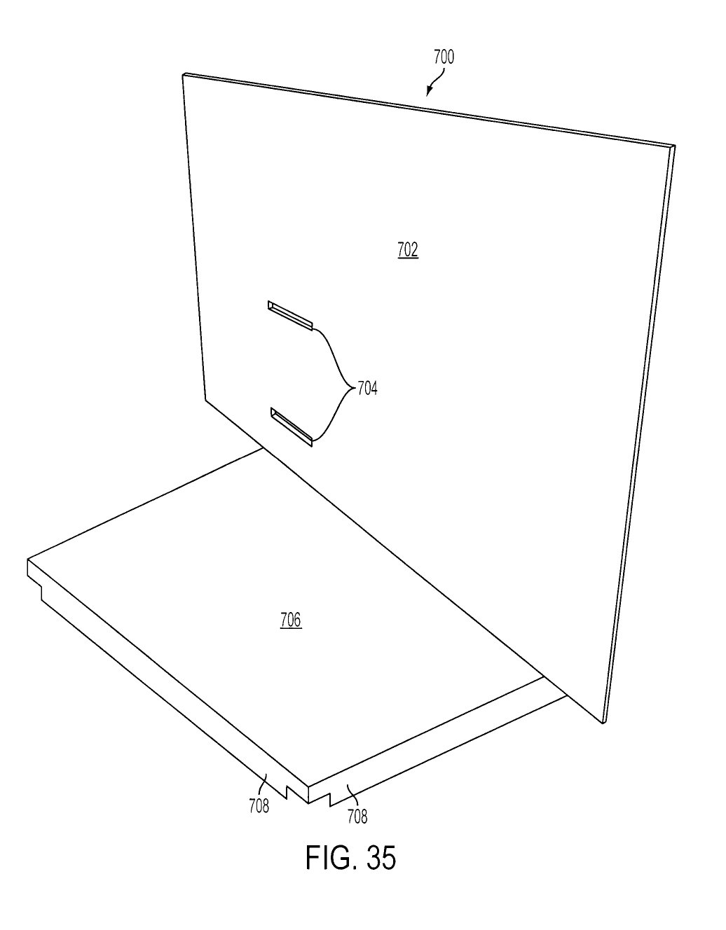

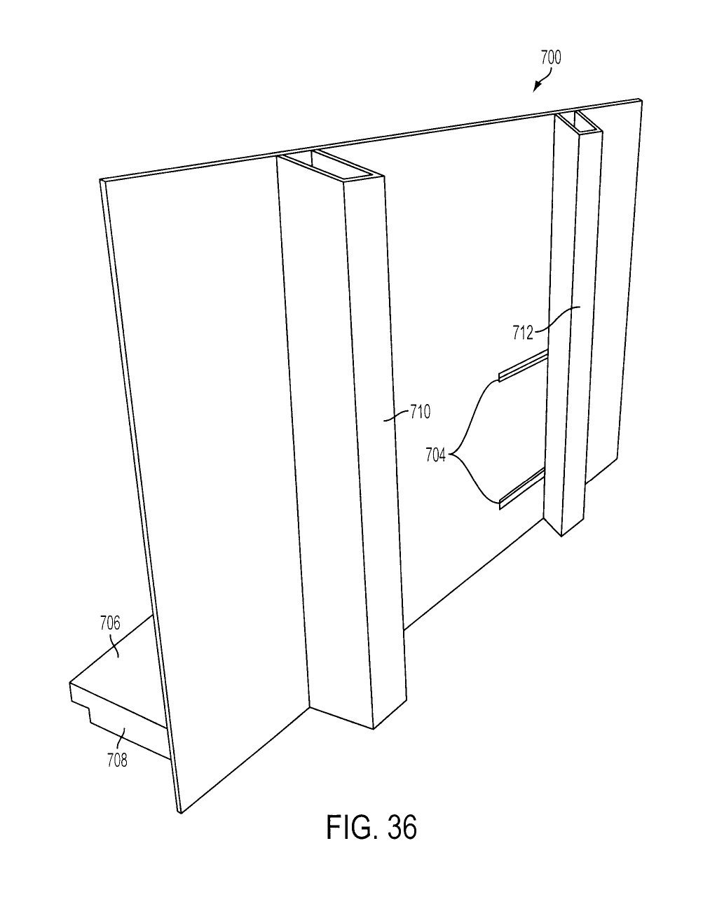

In other embodiments, a chair back riser 700, as shown in FIGS. 3 and 35-36 may be used. The chair back riser 700 comprises a single display surface 702 aligned towards the front of the display system 10. The display surface 702 may include price channel slots 704 to retain and display retail product information, however, other price channels forms may be used as well. Seat 706 is adjacent to and below the display surface 702 and fits across the top of the rack 300, covering the opening between the vertical support members 302, 304, 306, and 308. The seat 706 includes vertical edges 708 that extend downwards to engage and secure the chair back riser 700 to the rack 300. The vertical edges 708 also enhance the visual appearance of the display system 10 by hiding portions of the rack's tubes that may otherwise be visible to the consumer.

Two connecting tubes 710 and 712 are attached to the back of the display surface 702 and are spaced accordingly to align with the back tubes of the rack 300, fitting over the back vertical support members to secure the chair back riser 700 to the rack 300. As shown in this embodiment, the connecting tubes 710 and 712 may be formed from the same blank as the remainder of the chair back riser 700. However, in other embodiments, the connecting tubes 710 and 712 may be separate components and may be attached to the chair back riser 700 through other means, such as adhesion or the use of anchors.

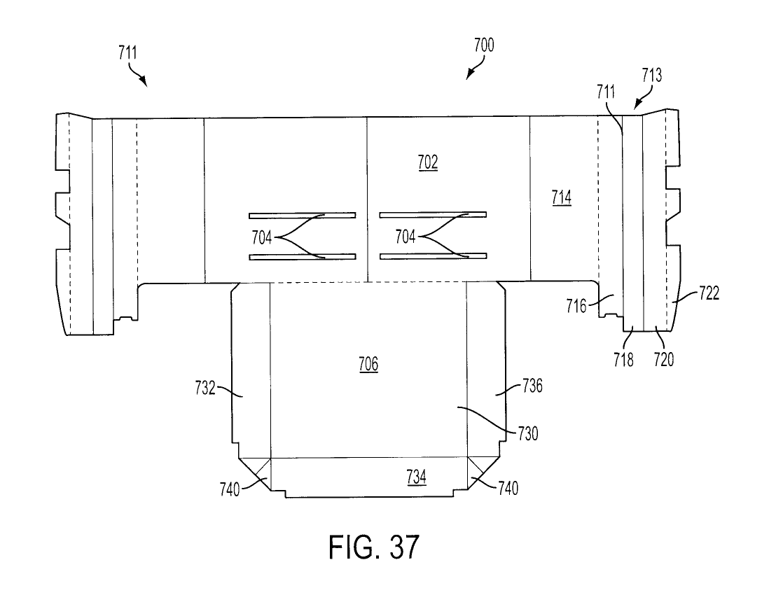

The chair back riser 700 may be formed from a single blank as shown in FIG. 37. The front display surface 702 has two extension portions 711 that extend from its side, with the seat portion 706 extending from its bottom edge. The two extension portions 711 form the connecting tubes 710 and 712. The extension portions 711 have several sub portions 714, 716, 718, 720, and 722 that are used to form the connecting tubes. The immediately adjacent sub portion 714 is folded against the back of the display surface 702. The tube forming sub portions 716, 718, and 720 are then folded and oriented such that sub portions 716 and 720 are perpendicular to the back of the display surface 702, with sub portion 718 oriented between the perpendicular sup portions 716 and 720 and parallel to the back of the display surface 702. The attachment sub portion 722 is then secured against the back of the display surface 702 to form a connecting tube 710 and 712. The attachment sub portion 722 may be shaped to have cutout portions in order to avoid interference with mounting on the rack 300.

As stated above, the seat 706 is formed from a seat extension 730 connected to the bottom of the display surface 702 of the chair back riser 700. The seat extension 730 has two side edge portions 732 and 736 and a front edge portion 734 that form the vertical edges 708 needed to secure the chair back riser 700. Between the front edge portion 734 and the two side edge portions 732 and 736 are triangular connecting portions 740. The edge portions 732, 734, and 736 are folded 90° from the seat extension 730 to form the vertical edges 708. The triangular connecting portions 740 are folded in half, from the apex to the hypotenuse, so that each half of the triangular connecting portions 740 engages one another. These engaging halves may be glued together in order to form gusset corners. The gusset corners reinforce the seat 706 and further secure the chair back display 700 on top of the rack 300. In some embodiments, an insert (not shown) may be placed in between the connecting tubes 710 and 712, providing an additional surface for graphics. Additionally, the back of the display surface 702 may have tabs that engage the top portion of a rear graphic display in order to further secure the chair back riser 700.

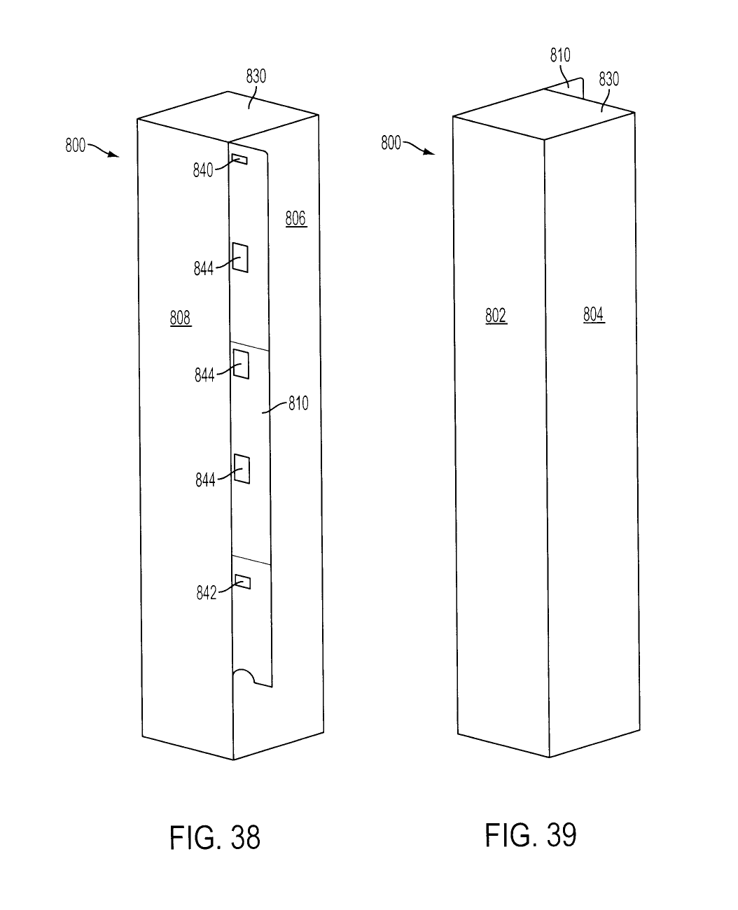

In one embodiment, shown in FIGS. 38-40, the display system 10 includes corner graphic segments 800 which provide additional surfaces 802 and 804 on which to place visuals or information. The display trays 100 encompass two sides of each corner graphic segment when mounted, so that only two surfaces 802 and 804 are visible on the rack 300. However, the number of visible surfaces may vary depending on the rack utilized as well as the customer's preference. A connecting extension 810 engages corner graphic segment 800 to the rack 300. The connecting extension 810 extends beyond the main body of the segment 800 and includes receiving slots 840 and 842 located near its top and bottom edges. These receiving slots 840 and 842 receive the free end 406 of the clips 400, connecting the corner graphic segment 800 to the rack 300. The connecting extension 810 also includes a plurality of openings 844 aligned with and between the receiving slots 840 and 842 that allow additional clips 400 to pass through the extension 810 to have access to additional display trays 100.

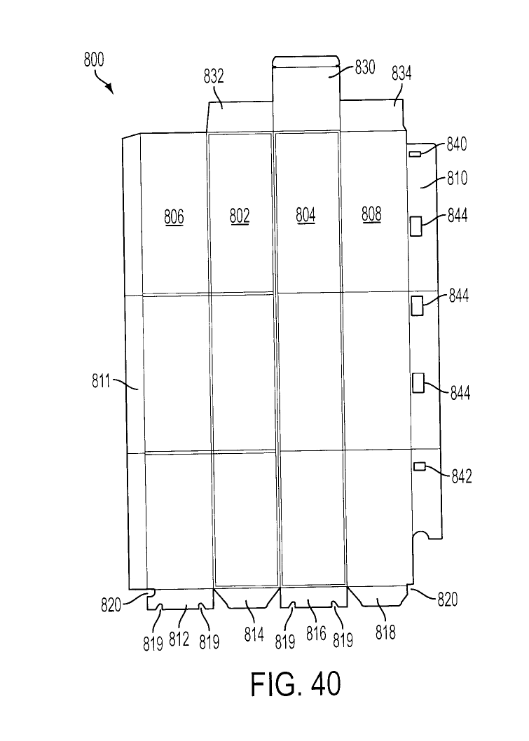

The corner graphic segment 800 may be formed from a blank as shown in FIG. 40. In the preferred embodiment, the corrugated sheet has four vertical segments, which correspond to the surfaces 802, 804, 806, and 808, an attachment portion 810, and an adhesive portion 811. The corrugated sheet is folded into a rectangular shape, with the adhesive portion 811 secured to the back of surface 802. However, the corner graphic segment may take other shapes, such as a three-sided vertical shape. Bottom folds 812, 814, 816, and 818 extend from the bottom of each vertical segment 802, 804, 806, and 808 and engage their adjacent fold, providing stability to the corner graphic segment 800. Two bottom folds 814 and 818 have a tab-shaped portion 820. Tabs 820 are received in slots 819. The bottom folds may not form a complete bottom for the corner graphic segment, but they may form an edge that provides a base for the segment. Notches 824 are formed from the bottom folds 812, 814, 816, and 818 and the vertical segments 806 and 808, similar to the ones of the riser 500 discussed above, to ensure that the corner graphic segment 800 fits snuggly against the foot plates 310 of the rack 300. Extending from top of three adjacent vertical segments 802, 804, and 808 are corresponding top folds 830, 832, and 834. The middle top fold 832 is longer than the other two folds 830 and 834, and has a securing portion at its end. However, the top fold arrangement could vary. The middle top fold 832 is folded over the other two top folds 830 and 834, with the securing portion engaging the back of the lone vertical segment 806 without a fold, providing a closed top surface for the corner graphic segments 800 and improving its appearance.

To ensure proper function, the corner graphic segments 800 should be mounted before the display trays 100 are assembled with the clips 400. In one embodiment, two corner graphic segments 800 are attached to the front vertical support members 304 and 306 of the rack 300. The corner graphic segments 800 are placed vertically on the rack's support members, so that when the display trays 100 are added, the corner graphic segments 800 will be positioned between the peripheral walls 120 and 130 of the display trays 100. This positioning hides the vertical support members from view, thereby enhancing the appearance of the display system 10.

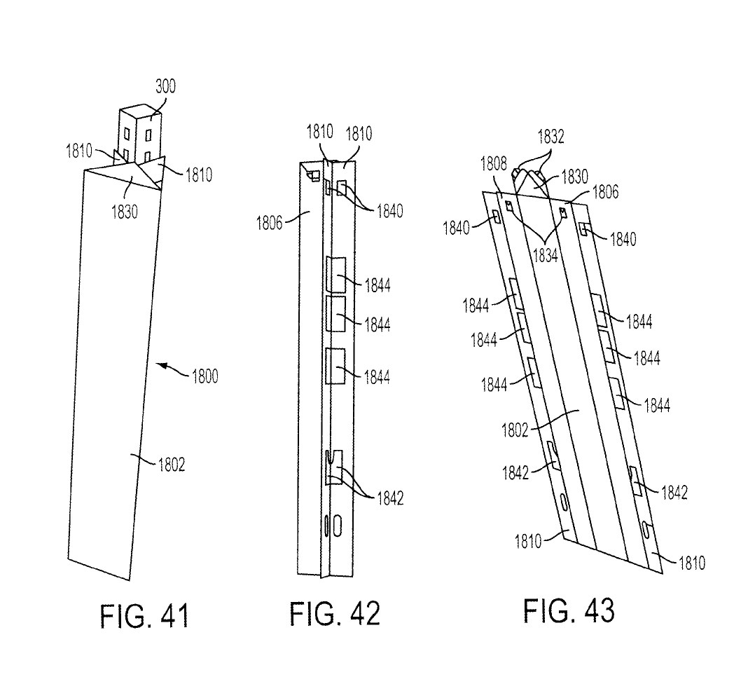

In another embodiment, shown in FIGS. 41-43, the corner graphic segments 1800 may have a triangular shape with one surface 1802 on which to place visuals or other information. The triangular corner graphic segment 1800 includes two connecting extensions 1810 that engage different surfaces of a vertical support member of the rack 300. The connecting extensions 1810 extend beyond the main body of the segment 1800 and include receiving slots 1840 and 1842 located near its top and bottom edge that receive the free ends 406 of clips 400. As mentioned above, the connecting extensions 1810 may include a plurality of openings 1844 aligned with and between the receiving slots 1840 and 1842 that allow additional clips 400 to pass through the extension 1810 to have access to additional display trays 100.

The corner graphic segment 1800 may be formed from a blank as shown in FIG. 43. The corrugated sheet has three vertical segments, which correspond to the surfaces 1802, 1806, and 1808, and the connection extensions 1810. To form the triangular component 1800, the corrugated sheet is folded into a triangular shape. A top portion 1830 extends from the top of one of the vertical segments 1802 and is folded downward to provide a top surface for the corner graphic segment 1800. In the illustrated embodiment, the top portion 1830 includes butterfly tabs 1832which are received in tab receiving cutouts 1834 to retain the corner graphic segment 1800. However, the segment 1800 may be formed and secured using any other suitable means as well.

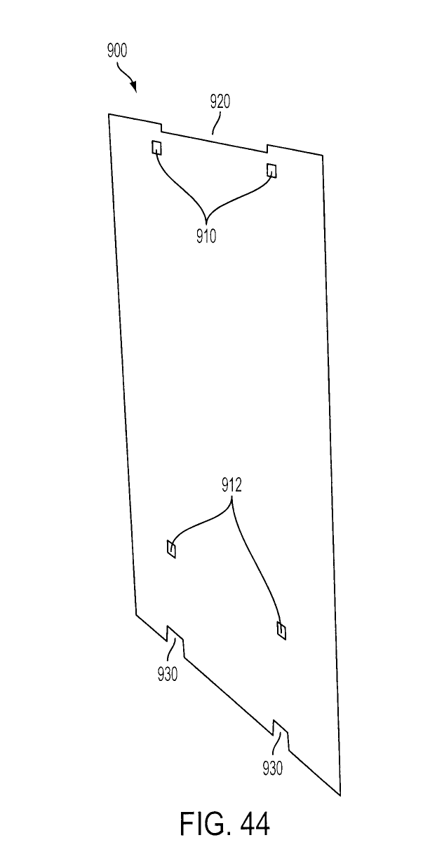

In one embodiment, shown in FIG. 44, the display system 10 includes a rear graphic guard 900, which covers the rear of the rack 300, guiding the consumer's attention away from the rack and to the retail product. The rear graphic guard 900 may also provide another surface for advertising and information.

The rear graphic guard 900 is attached to the rack using clips, the free ends of which are received in slots 910. Larger openings 912 in the lower third of the rear graphic guard 900 also receive the clips. Larger openings 912 are included because of the difficulty of aligning and inserting two rows of clips into a graphic panel. The rear graphic guard 900 includes notches 920 along its top edge that engage the riser or chair back riser, ensuring that the two fit well with one another, enhancing the appearance of the display system. Notches 930 are formed along the bottom edge of the rear graphic guard and fit around the mounted casters so that the rear graphic guard 900 need not be removed when using the casters to move the display system.

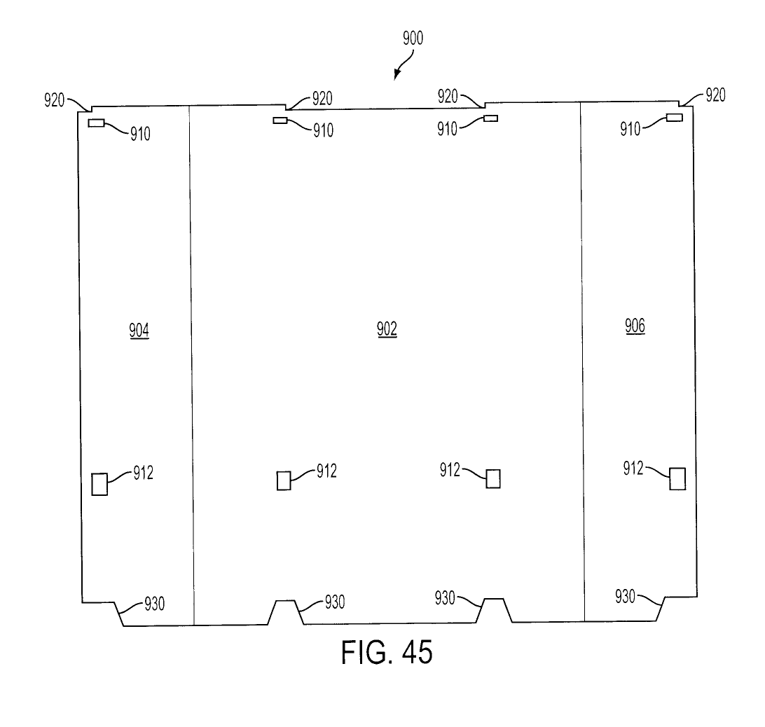

As shown in FIG. 45, the rear graphic guard 900 may be formed from a single blank having three main sections, a middle section 902 and two side sections 904 and 906. The side sections 904 and 906 are folded towards the middle section 902 to provide a double layer for the rear graphic guard 900.

A plug graphic display, similar to a rear graphic guard, may be optionally used to fill vacant tray space in a rack. The plug graphic display has a rectangular shape, and is formed from one corrugated sheet. The back surface of the plug graphic display includes openings along its back surface for clips to connect the plug graphic display to the rack. The plug graphic display also allows additional space for promotional and informational graphics.

### Method for Shipping and Displaying Retail Products

One method of this invention of shipping and displaying retail products quickly and efficiently includes providing display trays that may be used for packaging and shipping the retail goods, a collapsible display rack to which to attach the display trays and graphic design components. When the product is ready for display, the combination of the above allows quick and efficient assembly on the retail floor, leading to reduce costs and profit maximization.

To assist in selling a product, manufacturers and retailers may use a display employing graphics and advertisements further promoting and educating the consumer on the product. In one embodiment, such advertisements and images are placed on pre-configured graphic components. The graphic components are developed to meet specifications with regard to shape and size in order to integrate correctly with the display system 10. However, these specifications do not control the graphics chosen for the components. Once the graphics have been approved, the graphic components are shipped to the retailer for later assembly with the display system. Shipping the graphic display components separately and unattached reduces the chance of damage to the components.

Shipping the product in the display trays provides several advantages over traditional means of ship product, including shipping the product in an already assembled display, such as a half pallet display. First, packing the product in the display trays takes much less time than packing the product into a half pallet display. Second, a product-filled half pallet display takes up a great deal of space, much of which is occupied by graphic displays or unusable space given the nature and shape of the displays. The modular nature of the trays of this invention allows them to be effectively oriented so that shipping space is filled with product, rather than wasted space or graphics. The trays may be stacked upon one another and/or may be placed within smaller containers, or shippers, which are easier to manage than a half pallet display. In addition, shipping the display trays within the shipper prevents damage to the product and parcel shipping may be utilized instead of LTL shipping, providing a cheaper, more reliable, and easier-to-track means of shipping. Also, by using the display trays to ship the goods, as opposed to the whole display, less material is used, leaving more space available for product, which reduces the number of shipments needed. By having the rack on which the trays will be mounted already at the shipping destination, more unnecessary weight is eliminated, further reducing shipping costs.

The modular nature of the display trays, in conjunction with overall display system, allows the retailer more options in his or her sales approach. Unlike shipping a half pallet display, a varying amount of trays and product may be shipped to different stores to meet individual store need, allowing stores to utilize the displays without over extending themselves on product. Also, the display system allows more than one product type to be displayed and shipped. For example, one side of a display system may focus on presenting one title of a DVD, with sides of the corner display graphics and risers reflecting information on that DVD, while on an adjacent side video games may be featured with their own display graphics. When different products are to be displayed on the same rack, trays with the different product may be shipped, along with different graphic display components.

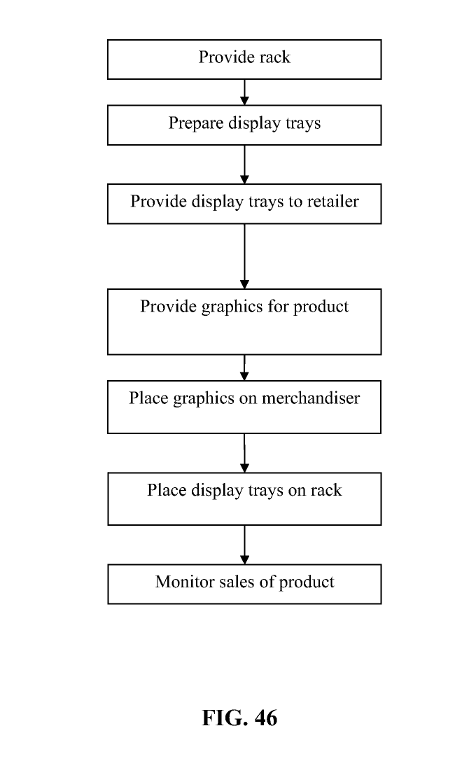

FIG. 46 shows a flow chart of how the display system is utilized. The following is one example of the method for using the display system. Different embodiments of the components of the display system may also be used as will be evident from the description below. A display rack 300 is first supplied to the retailer. Display trays 100 used to ship and display the product are supplied to a third party or packer. The display trays may arrive at the third party in an unassembled form. In such instances, upon arriving at the third party, the blanks are assembled into the display trays 100. Once assembled, product may then be packed into the display trays 100. The chip product retainers 370 may be inserted into the tray in order to secure the packed product and ensure that no product falls from the tray during shipping. The trays may then be placed in the shippers and shipped to the retailer.

When the product is received at the retail location, verification of the count sent is not a cumbersome task. No hand count of the product occurs. A tray holds a predetermined amount of product and the number of trays fit into a shipping box is also predetermined, so that verification may be conducted by counting the number of boxes or trays instead of hand-counting the product. In one embodiment, a radio frequency identification (RFID) may be attached to the trays for easier tracking and verification. The trays may be stored within their shippers until ready for display. There is no need for repackaging the product, as there is with a half pallet display.

To display the product, a rack 300 is placed at a desired location on the sales floor. As discussed above, in one embodiment, the rack 300 has caster wheels 380 that allow the rack 300 to be easily transported to the sales floor. The rack is then expanded and secured by inserting the inserts 356 into the apertures of the sliding plate and slide channel 354 and 344 respectfully. Upon expansion, according to the nature of the caster wheels 380, they may be removed or retracted.

Once the display rack 300 is placed in the desired location and expanded to the desired proportions, clips 400 may be secured along the rack 300. The retailer may already have the clips 400 in place along the tubes 302, 304, 306, and 308 before setting up the display rack 300, but if a new arrangement is needed, the clips 400 may be placed in the desired cutouts 320. In some embodiments of the invention, numbers may be found adjacent or approximate the desired cutouts 320 to assist in arranging the clips 400, display trays 100, and graphic display components 500, 800, and 900 in a predetermined pattern.

Once the clips 400 are in the appropriate locations, graphic display components 500, 800, and 900 and the display trays 100 may be attached. The corner graphic segments 800 should be attached to the clips 400 before the addition of the display trays 100. The receiving slots 840 and 842 of the corner graphic segments 800 may receive the free end 406 of a clip 400. The rear graphic guard 900 may be mounted to the rack 100, with the guard's slots 910 receiving the free end 406 of the clips 400 mounted on the rear vertical support members of the rack 100.

At the same time, the various riser embodiments 500, 600, and 700 may be mounted to the rack 300. As discussed above, the four-sided risers 500 and 600 include notches at their corner portions that create a flush fit against the tubes 302, 304, 306, and 308 of the rack. When used, the corrugated tube 681 is aligned between two support members of the rack to further secure the riser 600. In the case of the chair back riser 700, the connecting tubes 710 and 712 are aligned and placed on corresponding tubes of the rack. The vertical edges 708 of the chair back riser 700 may also engage the top portion of the rack 300, and the gusset corners further retain the riser 700 on the rack 300. The lower edges of the risers may engage the rear graphic guard 900 at its upper slots 920, creating another anchoring means for the risers.

Once the corner graphic segments are secured, the display trays 100 may be added. The display trays 100 may be taken directly out of the shippers, and the chip product retainers 370 may be removed. Before mounting the trays 100 to the rack 300, the easels 170 may be expanded from the easel cutout 184 that retain the easels 170 during shipping. The vertical and horizontal portions 172 and 174 are expanded. The free half 178 of the horizontal portion is folded over to have its tab 182 engage the slot 176 within the vertical portion 174, securing the extension of the easel along the back wall 150 of the tray 100. The tray 100 may then be mounted onto the rack, with the slots 160 receiving the free end 406 of the clips 400. When mounted, the easels 170 rest against the surface of a vertical support member, which causes the lip 102 to tilt up, improving the visibility and retaining of the product. For trays 100 that are mounted near the bottom of the rack, the wedge 200 may be mounted underneath the tray 100 to provide further support. As discussed above, the trays 100 may be mounted to the rack 100 in various arrangements. However, the retailer may follow given assembly instructions, matching the trays 100 to certain marked cutouts 320 if desired.

Use of the trays 100 allow the retailer to easily monitor the progress of sales and allow for easy replenishment. When a particular product sells well, an additional tray of that product may be ordered and shipped to replenish the stock.

The reduction of the rapid display system 10 is an easy process as well. The display trays and all graphic display components are removed from the rack, with or without product still intact. In the case of unsold product, the tray 100 may be removed from the rack 300 and displayed separately, with the tilting mechanism 192 being activated, and tilting the tray 100 in the same manner as with the function of the easels 170 on the rack 300. Alternatively, the product may be shipped back to the distributor. Any empty trays may be returned to the third party to be packed with a different product. The rack 300 may be collapsed and put into storage, occupying a small space, or may have new trays attached with different product.

To collapse the rack 300, the inserts 356 are removed, allowing the tubes 302, 304, 306, and 308 to move towards one another. The latch 370 may be employed upon complete collapse of the rack 300 to ensure that the tubes 302, 304, 306, and 308 do not expand during storage or transport of the rack 300. Casters 380 allow the rack 300 to be moved into storage or other area of display. The graphic display components may either be disposed of or, if generic, retained for future use.

As various modifications could be made in the constructions and methods herein described and illustrated without departing from the scope of the invention, it is intended that all matter contained in the foregoing description or shown in the accompanying drawings shall be interpreted as illustrative rather than limiting. For example, the rack and its method of construction described herein may be altered to include only three tubes. Also, the corner graphic segments may vary in construction and have three vertical sides. Additionally, all corrugated based components of the system may be made from other materials or combinations. Thus, the breadth and scope of this invention should not be limited by any of the above-described exemplary embodiments, but should be defined only in accordance with the following claims appended hereto and their equivalents.

What is claimed is:

1. A collapsible display rack comprising:
(a) at least three vertical support members, each vertical support member comprising a tube, first and second ends, and two surfaces;
(b) a slide channel assembly on each of the two surfaces of the vertical support member, each slide channel assembly comprising:
(i) a slide channel; and
(ii) a slide plate horizontally retained within the slide channel, limited only to vertical movement within the slide channel and movable in a vertical direction within the slide channel; and
(c) a plurality of pairs of cross support braces, each pair comprising a first and a second cross support brace, each brace comprising:
(i) a first end pivotally connected to one slide channel assembly on one of the at least three vertical support member; and
(ii) a second end pivotally connected to a second end of an adjacent vertical support member, wherein the first end of the first cross support brace and the second end of the second cross support brace are connected to the same vertical support member.

2. The display rack of claim 1, wherein at least one surface of each vertical support member comprises a plurality of cutout portions.

3. The display rack of claim 1, wherein the ratio of cross support braces to vertical support members is at least two to one.

4. The display rack of claim 1, wherein each pair of cross support braces further comprises:
(i) a locking bracket comprising a plurality of locking apertures and pivotally connected to the first cross support brace; and
(ii) a locking peg connected to the second cross support brace and received in one of the plurality of locking apertures.

5. The display rack of claim 1, wherein the slide channel and the sliding plate each further comprise at least one aperture capable of receiving an insert to arrest movement of the sliding assembly.

6. The display rack of claim 1, further comprising at least two caster wheels coupled to the second ends of two vertical support members.

7. The display rack of claim 6, wherein the two vertical support members extend further vertically than the remaining support members, the further extending portions operating as handles when transporting the rack using the caster wheels.

8. The display rack of claim 1, further comprising:
(a) a latch pivotally connected to one vertical support member comprising a slot; and
(b) a latch peg attached to an adjacent vertical support member wherein the peg is received in the slot to lock the rack in a collapsed position.

9. The display rack of claim 1, further comprising at least two retractable posts, each connected to a second end of a vertical support member.

10. A display system comprising:
(a) a display rack comprising at least one vertical surface; and
(b) at least one shipping and display tray comprising:
(i) a back wall comprising a top edge, and a bottom edge;
(ii) a front lip comprising a top edge and a bottom edge;
(iii) two peripheral walls connecting the back wall to the front lip; and
(iv) at least one retractable member comprising:
A. an extension member; and
B. a support member comprising a first retracted position for shipping and a second securing position for displaying the tray when mounted on the rack, wherein the extension member contacts the at least one vertical surface of the rack.

11. The display system of claim 10, wherein the back wall of the at least one tray further comprises at least one connection slot and wherein the display tray is mountable to the rack through the connection slot.

12. The display system of claim 10, wherein the back wall further comprises at least one retaining portion, the retaining portion receiving the support member when the support member is in the first retracted position for shipping.

13. The display system of claim 10 wherein the peripheral walls of the at least one tray further comprise a sloping top edge extending from the top edge of the back wall to the top edge of the front wall.

14. The display system of claim 10, further comprising a tilting mechanism coupled to a bottom portion of the tray, the tilting mechanism having a first retracted position within the bottom portion and a second extended position to tilt the display tray when the display tray is positioned on a horizontal surface.

15. The display system of claim 10, further comprising a removable product retainer adjacent the peripheral walls and the front lip.

16. A product display system comprising:
(a) a collapsible display rack comprising:
(i) at least three vertical support members, each vertical support member comprising a tube, first and second ends, and at least two surfaces;
(ii) a slide channel assembly on each surface of the vertical support member, each slide channel assembly comprising:
A. a slide channel; and
B. a slide plate retained within the slide channel and movable in a vertical direction within the slide channel; and
(iii) a plurality of pairs of cross support braces, each pair comprising a first and a second cross support brace, each brace comprising:
A. a first end pivotally connected to one slide channel assembly on one of the at least three vertical support members; and
B. a second end pivotally connected to a second end of an adjacent vertical support member,
wherein the first end of the first cross support brace and the second end of the second cross support brace are connected to the same vertical support member;
(b) a plurality of shipping and display trays, each display tray comprising:
(i) a back wall comprising a top edge, and a bottom edge;
(ii) a front lip comprising a top edge and a bottom edge;
(iii) two peripheral walls connecting the back wall to the front lip; and
(iv) at least one retractable member comprising:
A. an extension member; and
B. a support member comprising a first retracted position for shipping and a second securing position for displaying the tray when mounted on the rack, wherein the extension member contacts one of the at least two surfaces of a vertical support member of the rack;
(c) a plurality of clips for mounting on the rack; and
(d) at least one graphic display component.

17. The system of claim 16, wherein the at least one graphic display component further comprises:
(a) a riser for placement on top of the display rack and comprising at least one image display surface; and
(b) a plurality of corner graphic segments comprising at least one surface and at least one connection member having a plurality of slots that engage clips mounted on the rack.

18. The system of claim 17, wherein the riser further comprises at least three image display surfaces.

19. The system of claim 17, wherein the riser further comprises a seat portion adjacent the at least one image display surface and covering the top of the display rack.

20. The system of claim 19, wherein the riser further comprises at least two support tubes aligned with two of the at least three vertical support members.

21. The system of claim 17, further comprising a rear graphic guard.

22. The system of claim 16, wherein each clip further comprises:
(a) a straight end;
(b) an anchor member coupled to the straight end; and
(c) a free end.

23. The system of 22, wherein at least one surface of each vertical support member comprises a plurality of cutout portions adapted to receive the anchor member of the clip.

24. The system of claim 22, wherein the back wall of the display tray further comprises at least one connection slot adapted to receive the free end of the clip when the tray is mounted to the display rack.

25. The system of claim 16 wherein each pair of cross support braces further comprises:
(i) a locking bracket comprising a plurality of locking apertures and pivotally connected to the first cross support brace; and
(ii) a locking peg connected to the second cross support brace and received in one of the plurality of locking apertures.

26. A method of shipping and displaying product, comprising:
(a) receiving at least one graphic component and at least one shipping and display tray packed with product comprising:
(i) at least one retractable member comprising:
A. an extension member; and
B. a support member comprising a first retracted position and a second securing position for displaying the tray when mounted on a collapsible display rack;
(b) preparing the collapsible display rack to receive the at least one graphic component and the at least one shipping and display tray, comprising:
(i) moving the collapsible display rack to a desired location;
(ii) expanding the display rack;
(iii) securing the display rack; and
(iv) mounting a plurality of clips to the display rack,
wherein the collapsible display rack comprises:
(i) at least three vertical support members, each vertical support member comprising a slide channel assembly comprising:
A. a slide channel; and
B. a slide plate horizontally retained within the slide channel, limited only to vertical movement within the slide channel and movable in a vertical direction within the slide channel; and
(ii) a plurality of pairs of cross support braces, each pair comprising a first and a second cross support brace, each brace comprising a first end pivotally connected to one slide channel assembly on one of the at least three vertical support member and a second end pivotally connected to a second end of an adjacent vertical support member, wherein the first end of the first cross support brace and the second end of the second cross support brace are connected to the same vertical support member;
(c) mounting the plurality of graphic components to the display rack; and
(d) mounting the at least one shipping and display tray to the rack.

27. The method of claim 26, wherein mounting the at least one shipping and display tray to the rack comprises extending the retractable member of the shipping and display tray and receiving at least one clip mounted to the rack through at least one connection slot.

28. The method of claim 26, wherein coupling the plurality of graphic components to the display rack comprises:
(a) mounting a plurality of corner graphic segments to clips mounted on the display rack;
(b) mounting a rear graphic guard on a rear portion of the display rack; and
(c) placing a riser on a top portion of the display rack.

29. The method of claim 26, further comprising;
(a) assembling at least one shipping and display tray, the tray comprising:
(i) a back wall comprising a top edge, a bottom edge, at least one retaining cutout, and at least one connection slot;
(ii) a front lip comprising a top edge and a bottom edge; and
(iii) two peripheral walls connecting the back wall to the front lip;
(b) packing product in the at least one shipping and display tray;
(c) inserting a product retainer into the at least one shipping and display tray to retain the product, the product retainer adjacent the peripheral walls and the front lip; and
(d) shipping the at least one shipping and display tray,
prior to receiving at least one graphic component and at least one shipping and display tray packed with product.
